(19) United States
(12) Patent Application Publication
(10) Pub. No.: US 2025/0327659 A1
(43) Pub. Date: Oct. 23, 2025

(54) THREE-DIMENSIONAL MEASUREMENT DEVICE

(71) Applicant: Keyence Corporation, Osaka (JP)

(72) Inventors: Masayasu Ikebuchi, Osaka (JP); Shota Matsudo, Osaka (JP); Hitoshi Sakai, Osaka (JP); Shuji Shimonaka, Osaka (JP)

(73) Assignee: Keyence Corporation, Osaka (JP)

(21) Appl. No.: 19/254,059

(22) Filed: Jun. 30, 2025

Related U.S. Application Data
(63) Continuation of application No. PCT/JP2024/000595, filed on Jan. 12, 2024.

(30) Foreign Application Priority Data
Feb. 7, 2023 (JP) 2023-16769
Dec. 8, 2023 (JP) 2023-207974

(51) Int. Cl. G01B 11/25

(52) U.S. Cl. CPC G01B 11/25

(57) ABSTRACT

High-speed scanning is implemented while securing convenience of wireless communication. A three-dimensional measurement device 1 includes: a three-dimensional scanner 2 that processes a first image including pattern light to generate first measurement information; an imaging unit 3 that moves a field of view to make the three-dimensional scanner 2 be within the field of view and includes a first wireless communication unit that transmits second measurement information generated by processing a second image including a marker of the three-dimensional scanner 2; and a three-dimensional data generation unit 4 that includes a second wireless communication unit configured to receive the second measurement information transmitted via the first wireless communication unit and generates a point cloud indicating a three-dimensional shape of a measurement target based on the first measurement information generated by the scanner image processing unit and the second measurement information received via the second wireless communication unit.

### CROSS-REFERENCE TO RELATED APPLICATIONS

The present application is a continuation of International Application No. PCT/JP2024/000595, filed Jan. 12, 2024, which in turn claims foreign priority based on Japanese Patent Application No. 2023-16769, filed Feb. 7, 2023 and No. 2023-207974, filed Dec. 8, 2023, the contents of which are incorporated herein by references.

### TECHNICAL FIELD

The disclosure relates to a three-dimensional measurement device including an imaging unit that captures an image of a three-dimensional scanner having a marker.

### BACKGROUND ART

For example, Patent Literature 1 discloses that three-dimensional coordinate measurement of a measurement target is performed using a contact-type probe having a contact part to be brought into contact with a desired part of the measurement target. In Patent Literature 1, the contact-type probe and an imaging unit are configured to communicate with each other in a wireless manner, images of a plurality of markers provided in the contact-type probe can be captured by the imaging unit installed at a position distant from the contact-type probe, and three-dimensional coordinates of a contact position of the contact-type probe can be calculated based on a marker image generated by the imaging unit.

### CITATION LIST

### Patent Literature

Patent Literature 1: JP 2020-148516 A

### SUMMARY OF INVENTION

### Technical Problem

Meanwhile, coordinates can be measured only at a part in contact with the probe since the probe is of the contact type in a device in Patent Literature 1. In this regard, if a three-dimensional scanner of a non-contact type is used, measurement of a wider range, that is, scanning of a wider range of the measurement target becomes possible. However, in order to implement the scanning of a wider range at a higher speed than the device in Patent Literature 1, it is necessary to transmit an image acquired by the three-dimensional scanner from the three-dimensional scanner to a processing unit at a high frame rate.

However, a data amount of the image acquired by the three-dimensional scanner is much larger than a data amount indicating a position of the point as in Patent Literature 1, and there is a case where it is difficult to transmit such image data having a large data amount to the processing unit at a high frame rate due to a restriction of a communication band. In particular, this problem becomes remarkable when it is attempted to secure convenience by wireless communication as in Patent Literature 1.

The disclosure has been made in view of such a point, and an object thereof is to implement high-speed scanning by a three-dimensional scanner while securing convenience of wireless communication.

### Solution to Problem

In order to achieve the above object, the disclosure can assume a three-dimensional measurement device that measures a three-dimensional shape of a measurement target. The three-dimensional measurement device includes: a three-dimensional scanner including a scanner light source that emits pattern light, a scanner imaging part that captures an image of the pattern light emitted by the scanner light source to generate a first image including the pattern light, a scanner image processing unit that processes the first image generated by the scanner imaging part to generate first measurement information, and a plurality of markers; an imaging unit including a movable imaging part that moves a field of view to make the three-dimensional scanner be within the field of view, and captures images of the markers for measuring a position and a posture of the three-dimensional scanner to generate a second image including the markers, a camera image processing unit that processes the second image generated by the movable imaging part to generate second measurement information, and a first wireless communication unit that transmits the second measurement information generated by the camera image processing unit; and a three-dimensional data generation unit that includes a second wireless communication unit configured to receive the second measurement information transmitted via the first wireless communication unit, and generates a point cloud indicating the three-dimensional shape of the measurement target based on the first measurement information generated by the scanner image processing unit and the second measurement information received via the second wireless communication unit.

According to this configuration, when the scanner light source emits the pattern light, the scanner imaging part generates the first image including the pattern light, and the markers are, for example, self-luminous markers, the markers emit light and the movable imaging part generates the second image including the markers. The second measurement information generated by processing the second image generated by the movable imaging part is transmitted to the three-dimensional data generation unit by the first wireless communication unit. At this time, the amount of data to be transmitted can be reduced by transmitting the second measurement information as compared with a case where image data of the second image is directly transmitted, and thus it is possible to perform transmission at a high frame rate while securing convenience by wireless communication. Then, the three-dimensional data generation unit can generate the point cloud indicating the three-dimensional shape of the measurement target based on the second measurement information transmitted by the first wireless communication unit and the first measurement information generated by the scanner image processing unit.

The three-dimensional scanner may include a third wireless communication unit configured to transmit the first measurement information generated by the scanner image processing unit to the first wireless communication unit. In this case, the first wireless communication unit can transmit the first measurement information received via the third wireless communication unit to the second wireless communication unit together with the second measurement information corresponding to the first measurement information.

A battery unit that is portable and configured to supply power to the three-dimensional scanner may be further provided. The three-dimensional scanner further includes a power supply port that receives power supply from the battery unit, and thus the three-dimensional shape of the measurement target can be measured using the three-dimensional scanner even at a place distant from a commercial power supply.

Each of the first wireless communication unit and the third wireless communication unit may include an optical communication interface and a radio communication interface. In this case, the imaging unit may include a synchronization mechanism that generates identification information for identifying a synchronous execution timing based on a measurement instruction, and the three-dimensional scanner may include a measurement control part that synchronizes the emission of the pattern light from the scanner light source, the imaging by the scanner imaging part, and the light emission of the self-luminous markers. When the optical communication interface of the first wireless communication unit transmits a synchronization signal generated by the synchronization mechanism to the three-dimensional scanner, the three-dimensional scanner receives the synchronization signal via the optical communication interface of the third wireless communication unit, and the measurement control part can synchronize the emission of the pattern light from the scanner light source, the imaging by the scanner imaging part, and the emission of the self-luminous markers in response to reception of the synchronization signal via the optical communication interface of the third wireless communication unit.

The three-dimensional scanner can also transmit the first measurement information generated by the scanner image processing unit to the imaging unit via the radio communication interface of the third wireless communication unit. In this case, the imaging unit can receive the first measurement information via the radio communication interface of the first wireless communication unit, and transmit the received first measurement information and the second measurement information generated by the camera image processing unit to the second wireless communication unit.

Further, a contact-type probe that includes a plurality of the self-luminous markers and a fourth wireless communication unit configured to receive the synchronization signal, and indicates a position of a measurement point may be further provided. In this case, the movable imaging part can generate a third image including the plurality of self-luminous markers provided in the contact-type probe, the camera image processing unit can process the third image generated by the movable imaging part to generate third measurement information, and the first wireless communication unit can transmit the third measurement information generated by the camera image processing unit. This also enables coordinate measurement using the contact-type probe.

The fourth wireless communication unit may include an optical communication interface and a radio communication interface to receive the synchronization signal.

The three-dimensional measurement device may include a first light source module including: a first laser light source that emits laser light; a first condenser lens that condenses the laser light emitted from the first laser light source; a first optical element that branches the laser light condensed by the first condenser lens into a plurality of light beams; and a first Powell lens (also referred to as a degauss lens) that one-dimensionally expands each of the plurality of light beams branched by the first optical element to generate multi-line light.

The three-dimensional measurement device may include a second light source module including: a second laser light source that emits laser light; a second condenser lens that condenses the laser light emitted from the second laser light source; and a second Powell lens that one-dimensionally expands the laser light condensed by the second condenser lens to generate single-line light of light stronger than each line light of the multi-line light.

The three-dimensional measurement device may include: a scanner imaging part that captures an image of the multi-line light emitted from the first light source module or the single-line light emitted from the second light source module to generate a first image including the multi-line light or the single-line light; and a three-dimensional data generation unit that generates a point cloud indicating the three-dimensional shape of the measurement target based on the first image generated by the scanner imaging part.

The multi-line light and the single-line light may be configured using light emitted from the same laser light source. Further, two or more light source modules for the multi-line light may be provided. Further, a cylindrical lens may be used instead of the Powell lens.

The three-dimensional measurement device may further include a measurement control part that synchronizes emission of the multi-line light from the first light source module or emission of the single-line light from the second light source module with imaging by the scanner imaging part, and receives a switching input for switching between the emission of the multi-line light and the emission of the single-line light.

In this case, the measurement control part can control the first laser light source to synchronously execute the emission of the multi-line light from the first light source module and the imaging by the scanner imaging part. Then, the first laser light source and the second laser light source are controlled in response to reception of the switching input, and switching control can be executed in which the emission of the single-line light from the second light source module and the imaging by the scanner imaging part are synchronously executed after the emission of the multi-line light from the first light source module is stopped. Further, the three-dimensional data generation unit may combine a point cloud indicating a three-dimensional shape of the measurement target generated based on the first image including the multi-line light and a point cloud indicating a three-dimensional shape of the measurement target generated based on the first image including the single-line light to generate a point cloud indicating the three-dimensional shape of the measurement target.

The measurement target may have a specular reflection region and a non-specular reflection region. In this case, the three-dimensional data generation unit generates a point cloud indicating a three-dimensional shape of the non-specular reflection region of the measurement target based on the first image including the multi-line light, and generates a point cloud indicating a three-dimensional shape of the specular reflection region of the measurement target based on the first image including the single-line light. The three-dimensional data generation unit combines the point cloud indicating the three-dimensional shape of the non-specular reflection region of the measurement target and the point cloud indicating the three-dimensional shape of the specular reflection region of the measurement target to generate the point cloud indicating the three-dimensional shape of the measurement target including the specular reflection region and the non-specular reflection region.

The scanner imaging part may further include a scanner image processing unit that includes a first camera and a second camera and processes the first image generated by the scanner imaging part to generate first measurement information, and the scanner image processing unit may generate a plurality of pieces of first information from the first image including the multi-line light and generate a plurality of pieces of first information from the first image including the single-line light. The three-dimensional data generation unit can generate a point cloud indicating a three-dimensional shape of the measurement target based on a plurality of pieces of the first measurement information generated from the first image including the multi-line light and a positional relationship between the first camera and the second camera, can specify true measurement information among the plurality of pieces of first measurement information generated from the first image including the single-line light based on the positional relationship between the first camera and the second camera, and can generate a point cloud indicating the three-dimensional shape of the measurement target based on the specified true measurement information and the positional relationship between the first camera and the second camera.

The first light source module may further include: a first small-diameter lens barrel that is provided between the first laser light source and the first Powell lens and has a radial length smaller than a power distribution width of the laser light; and a first slit forming member that blocks light at an end of the multi-line light generated by the first Powell lens.

The second light source module may further include: a second small-diameter lens barrel that is provided between the second condenser lens and the second Powell lens and has a radial length smaller than a power distribution width of the laser light; and a second slit forming member that blocks light at an end of the single-line light generated by the second Powell lens.

The three-dimensional measurement device may include: a three-dimensional scanner including a scanner light source that emits pattern light, a scanner imaging part that captures an image of the pattern light emitted by the scanner light source to generate a first image including the pattern light, a scanner image processing unit that processes the first image generated by the scanner imaging part to generate first measurement information, and a plurality of marker blocks in which self-luminous markers emitting visible light and invisible light are provided; an imaging unit including a movable imaging part that moves a field of view to make the three-dimensional scanner be within the field of view, and captures images of the self-luminous markers emitting the invisible light for measuring a position and a posture of the three-dimensional scanner to generate a second image including the self-luminous markers, and a camera image processing unit that processes the second image generated by the movable imaging part to generate second measurement information; a synchronization mechanism that generates identification information for identifying a synchronous execution timing based on a measurement instruction; a measurement control part that synchronizes emission of the pattern light from the scanner light source, imaging by the scanner imaging part, light emission of the self-luminous markers, and the imaging by the movable imaging part in response to the generation of the identification information by the synchronization mechanism; and a three-dimensional data generation unit that generates a point cloud indicating the three-dimensional shape of the measurement target based on the first measurement information generated by the scanner image processing unit and the second measurement information generated by the camera image processing unit.

In this case, the three-dimensional data generation unit is configured to determine whether the marker block can be detected from the movable imaging part, and change a light emission state of the self-luminous markers between a case where it is determined that the marker block can be detected and a case where it is determined that the marker block cannot be detected. For example, the self-luminous markers included in the marker block that can be detected from the movable imaging part can be caused to emit light in a first color having a visible light wavelength when it is determined that the marker block can be detected, and the self-luminous markers included in the marker block that cannot be detected from the movable imaging part can be caused to emit light in a second color different from the first color with a visible light wavelength when it is determined that the marker block cannot be detected. For example, the first color can be green and the second color can be red. Further, the self-luminous markers included in the marker block that can be detected from the movable imaging part may be turned on when it is determined that the marker block can be detected, and the self-luminous markers included in the marker block that cannot be detected from the movable imaging part may be caused to blink when it is determined that the marker block cannot be detected.

The three-dimensional measurement device may include: a three-dimensional scanner including a scanner light source that emits pattern light, a scanner imaging part that captures an image of the pattern light emitted by the scanner light source to generate a first image including the pattern light, a scanner image processing unit that processes the first image generated by the scanner imaging part to generate first measurement information, and a plurality of marker blocks in which retroreflective markers and indicator lamps are provided; an imaging unit including a movable imaging part that moves a field of view to make the three-dimensional scanner be within the field of view, and generates a second image including the retroreflective markers for measuring a position and a posture of the three-dimensional scanner, and a camera image processing unit that processes the second image generated by the movable imaging part to generate second measurement information; a synchronization mechanism that generates identification information for identifying a synchronous execution timing based on a measurement instruction; a measurement control part that synchronizes emission of the pattern light from the scanner light source, imaging by the scanner imaging part, and imaging by the movable imaging part in response to the generation of the identification information by the synchronization mechanism; and a three-dimensional data generation unit that generates a point cloud indicating the three-dimensional shape of the measurement target based on the first measurement information generated by the scanner image processing unit and the second measurement information generated by the camera image processing unit.

In this case, the three-dimensional data generation unit can determine whether the marker blocks can be detected from the movable imaging part, and cause the indicator lamps of the marker blocks to emit light in different colors according to the determination result. That is, display control of the indicator lamps is executed such that a user can easily grasp whether the marker blocks can be detected from the movable imaging part.

The three-dimensional measurement device may include: a three-dimensional scanner including a scanner light source that emits pattern light, a scanner imaging part that captures an image of the pattern light emitted by the scanner light source to generate a first image including the pattern light, a scanner image processing unit that processes the first image generated by the scanner imaging part to generate first measurement information, and a plurality of marker blocks in which self-luminous markers emitting visible light and invisible light are provided; an imaging unit including a movable imaging part that moves a field of view to make the three-dimensional scanner be within the field of view, and captures images of the self-luminous markers emitting the invisible light for measuring a position and a posture of the three-dimensional scanner to generate a second image including the self-luminous markers, and a camera image processing unit that processes the second image generated by the movable imaging part to generate second measurement information; a synchronization mechanism that generates identification information for identifying a synchronous execution timing based on a measurement instruction; a measurement control part that synchronizes emission of the pattern light from the scanner light source, imaging by the scanner imaging part, light emission of the self-luminous markers, and the imaging by the movable imaging part in response to the generation of the identification information by the synchronization mechanism; and a three-dimensional data generation unit that generates a point cloud indicating the three-dimensional shape of the measurement target based on the first measurement information generated by the scanner image processing unit and the second measurement information generated by the camera image processing unit.

In this case, the three-dimensional data generation unit can determine whether the position and posture of the three-dimensional scanner can be specified from the movable imaging part based on the second image, can cause the self-luminous markers included in the marker blocks to emit light in a first color having a visible light wavelength, and can cause the self-luminous markers included in the marker blocks to emit light in a second color different from the first color with a visible light wavelength when it is determined that the position and posture of the three-dimensional scanner cannot be specified.

When it is determined that the position and posture of the three-dimensional scanner can be specified, the three-dimensional data generation unit can also cause the marker block that can be detected from the movable imaging part and the marker block that cannot be detected from the movable imaging part to emit light in a distinguishable manner. The markers may be self-luminous markers or retroreflective markers.

The three-dimensional measurement device may include: a three-dimensional scanner including a scanner imaging part that captures an image of pattern light emitted by a scanner light source to generate a first image including the pattern light, a scanner image processing unit that processes the first image generated by the scanner imaging part to generate first measurement information, and a plurality of self-luminous markers; an imaging unit including a movable imaging part that moves a field of view to make the three-dimensional scanner be within the field of view, and captures images of the self-luminous markers for measuring a position and a posture of the three-dimensional scanner to generate a second image including the self-luminous markers, and a camera image processing unit that processes the second image generated by the movable imaging part to generate second measurement information; a synchronization mechanism that generates identification information for identifying a synchronous execution timing based on a measurement instruction; a measurement control part that synchronizes emission of the pattern light from the scanner light source, imaging by the scanner imaging part, light emission of the self-luminous markers, and the imaging by the movable imaging part in response to the generation of the identification information by the synchronization mechanism; and a three-dimensional data generation mechanism that generates a point cloud indicating the three-dimensional shape of the measurement target based on the first measurement information generated by the scanner image processing unit and the second measurement information generated by the camera image processing unit.

The three-dimensional scanner may further include a first transmission unit that transmits the first measurement information generated by the scanner image processing unit and identification information corresponding to the first measurement information and generated by the synchronization mechanism to be tied to each other.

The imaging unit may further include a second transmission unit that transmits the second measurement information generated by the camera image processing unit and identification information corresponding to the second measurement information and generated by the synchronization mechanism to be tied to each other.

The three-dimensional data generation mechanism can receive the first measurement information generated by the scanner image processing unit, the identification information corresponding to the first measurement information, the second measurement information generated by the camera image processing unit, and the identification information corresponding to the second measurement information, and generate the point cloud indicating the three-dimensional shape of the measurement target based on the received first measurement information, identification information corresponding to the first measurement information, second measurement information, and identification information corresponding to the second measurement information.

The imaging unit may further include a fixed imaging part that captures an image of the movable imaging part. The measurement control part can synchronize imaging by the fixed imaging part with imaging by the movable imaging part in response to the generation of the identification information by the synchronization mechanism.

The movable imaging part may be provided with a plurality of markers moving as the field of view of the movable imaging part moves. The fixed imaging part can capture images of the plurality of markers provided in the movable imaging part to generate a third image including the markers. The camera image processing unit may process the third image generated by the fixed imaging part to generate third measurement information, the second transmission unit may transmit the third measurement information generated by the camera image processing unit and the identification information, which is generated by the synchronization mechanism and corresponds to the third measurement information, to be tied to each other, and the three-dimensional data generation mechanism may generate the point cloud indicating the three-dimensional shape of the measurement target based on the first measurement information generated by the scanner image processing unit, the second measurement information generated by the camera image processing unit, and the third measurement information generated by the camera image processing unit.

The scanner image processing unit can generate the first measurement information with the scanner imaging part as a reference, the first transmission unit can transmit the first measurement information with the scanner imaging part as the reference and the identification information corresponding to the first measurement information generated by the synchronization mechanism, the camera image processing unit can generate the second measurement information with the movable imaging part as a reference and the third measurement information with the fixed imaging part as a reference, the second transmission unit can transmit the first measurement information with the scanner imaging part as the reference and the identification information corresponding to the first measurement information, the first measurement information and the identification information being transmitted by the first transmission unit, and the second measurement information with the movable imaging part as the reference and the identification information corresponding to the second measurement information and the third measurement information with the fixed imaging part as the reference and the identification information corresponding to the second measurement information, the second measurement information and the third measurement information being generated by the camera image processing unit, and the three-dimensional data generation mechanism can generate the point cloud indicating the three-dimensional shape of the measurement target with the fixed imaging part as a reference based on the first measurement information with the scanner imaging part as the reference, the second measurement information with the movable imaging part as the reference, and the third measurement information with the fixed imaging part as the reference.

The scanner image processing unit can perform edge extraction processing on the first image to generate edge data as the first measurement information.

The camera image processing unit can perform processing of extracting a center of each of the self-luminous markers on the second image to generate center position information of each of the self-luminous markers as the second measurement information.

The three-dimensional scanner may further include a first storage unit that stores arrangement information of the plurality of self-luminous markers. The camera image processing unit can generate the center position information of each of the self-luminous markers as the second measurement information based on the arrangement information of the plurality of self-luminous markers stored in the first storage unit of the three-dimensional scanner and the second image.

The first storage unit can further store calibration data of the three-dimensional scanner, and the three-dimensional data generation mechanism can generate the point cloud indicating the three-dimensional shape of the measurement target based on the calibration data stored in the first storage unit of the three-dimensional scanner, the first measurement information, and the second measurement information.

The camera image processing unit can perform processing of extracting a center of each of the self-luminous markers on the second image to generate position and posture information of each of the self-luminous markers with respect to the movable imaging part as the second measurement information based on center position information of each of the self-luminous markers obtained by the processing. Further, the camera image processing unit may include an image processing circuit.

A memory that sequentially accumulates the first measurement information generated by the scanner image processing unit and an association unit that associates the first measurement information and the second measurement information based on the identification information may be provided. The association unit can specify the first measurement information having the identification information tied to the second measurement information from among a plurality of pieces of the first measurement information accumulated in the memory, and associate the specified first measurement information with the second measurement information.

The memory can be provided in the imaging unit and sequentially accumulate the first measurement information transmitted from the first transmission unit, and the second transmission unit can transmit the first measurement information and the second measurement information associated by the association unit to the three-dimensional data generation mechanism.

The scanner light source can emit multi-line light as the pattern light, the scanner imaging part can generate a multi-line image as the first image, and the scanner image processing unit can process the multi-line image to generate edge data as the first measurement information. Advantageous Effects of Invention

As described above, when the three-dimensional data generation unit generates the point cloud indicating the three-dimensional shape of the measurement target based on the first measurement information generated by processing the first image including the pattern light by the scanner image processing unit and the second measurement information generated by processing the second image including the markers by the camera image processing unit, the second measurement information can be transmitted to the three-dimensional data generation unit by wireless communication. As a result, the high-speed scanning can be implemented by the three-dimensional scanner while securing the convenience of the wireless communication.

### BRIEF DESCRIPTION OF DRAWINGS

FIG. 1 is a view illustrating a configuration of a three-dimensional measurement device according to an embodiment of the invention.

FIG. 2 is a block diagram of an imaging unit and a processing unit.

FIG. 3 is a perspective view of a three-dimensional scanner as viewed from below.

FIG. 4 is a right side view of the three-dimensional scanner.

FIG. 5 is a plan view of the three-dimensional scanner.

FIG. 6 is a bottom view of the three-dimensional scanner.

FIG. 7 is a front view of the three-dimensional scanner.

FIG. 8 is a block diagram illustrating a circuit configuration of the three-dimensional scanner.

FIG. 9 is a block diagram illustrating a circuit configuration of a probe.

FIG. 10 is a view illustrating examples of a multi-line image and edge data.

FIG. 11 is a view illustrating an example of a scanner marker image and center position information of a scanner marker.

FIG. 12 is a flowchart illustrating an example of a procedure of three-dimensional shape measurement of a measurement target by the three-dimensional measurement device.

FIG. 13 is a flowchart illustrating an example of a procedure of data matching processing.

FIG. 14 is a view according to a first modification of the embodiment, which corresponds to FIG. 1.

FIG. 15 is a view according to a second modification of the embodiment, which corresponds to FIG. 1.

FIG. 16 is a cross-sectional view illustrating a structure of a first scanner light source.

FIG. 17 is a cross-sectional view illustrating a structure of a second scanner light source.

FIG. 18 is a graph illustrating optical characteristics of a Powell lens.

FIG. 19 is a view corresponding to FIG. 12 in a case where a scanner synchronization mechanism is provided.

FIG. 20 is a view corresponding to FIG. 3 according to an example including retroreflective markers. FIG. 21 is a view illustrating an example of a user interface for switching the three-dimensional scanner from an inactive state to an active state.

### DESCRIPTION OF EMBODIMENTS

Hereinafter, an embodiment of the invention will be described in detail with reference to the drawings. Note that the following preferred embodiment is described merely as an example in essence, and there is no intention to limit the invention, its application, or its use.

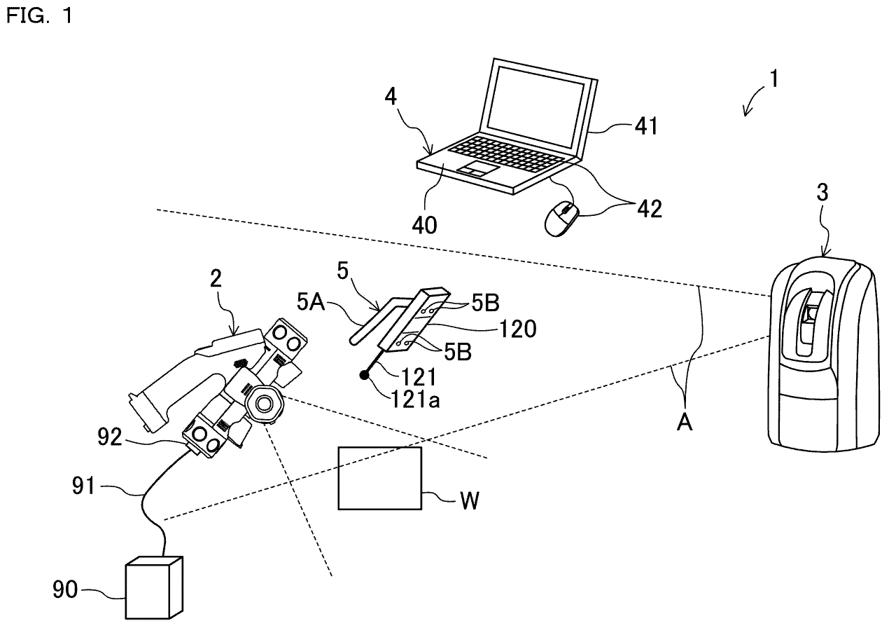

FIG. 1 is a view illustrating a configuration of a three-dimensional measurement device 1 according to the embodiment of the invention. The three-dimensional measurement device 1 is a measuring instrument that measures a three-dimensional shape and three-dimensional coordinates of a measurement target W, and includes a non-contact-type three-dimensional scanner 2 including a plurality of self-luminous markers (scanner markers), a contact-type probe 5 including a plurality of self-luminous markers (probe markers), an imaging unit 3 that captures images of the plurality of scanner markers included in the three-dimensional scanner 2 and images of the plurality of probe markers included in the probe 5, and a processing unit 4 that measures the three-dimensional shape and three-dimensional coordinates of the measurement target W. The markers are not necessarily self-luminous markers. The three-dimensional scanner 2 is provided separately from the imaging unit 3 and the processing unit 4, and a measurement worker can bring the three-dimensional scanner 2 to the vicinity of the measurement target W located at a place distant from the imaging unit 3 and the processing unit 4 and cause the three-dimensional scanner 2 to generate a bright line image. Further, the probe 5 is provided separately from the imaging unit 3 and the processing unit 4, and the measurement worker can bring the probe 5 to the vicinity of the measurement target W located at a place distant from the imaging unit 3 and the processing unit 4 and specify a measurement point using the probe 5. The probe 5 is not necessarily provided.

### Configuration of Imaging Unit 3

The imaging unit 3 is a unit that captures images of a plurality of scanner markers (described later) provided in the three-dimensional scanner 2 to generate a scanner marker image (corresponding to a second image of the invention) including the plurality of scanner markers, and captures images of a plurality of probe markers (described later) provided in the probe 5 to generate a probe marker image (corresponding to a third image of the invention) including the plurality of probe markers. The scanner marker image including the scanner markers is generated at the time of measurement using the three-dimensional scanner 2, and the probe marker image including the probe markers is generated at the time of measurement using the probe 5.

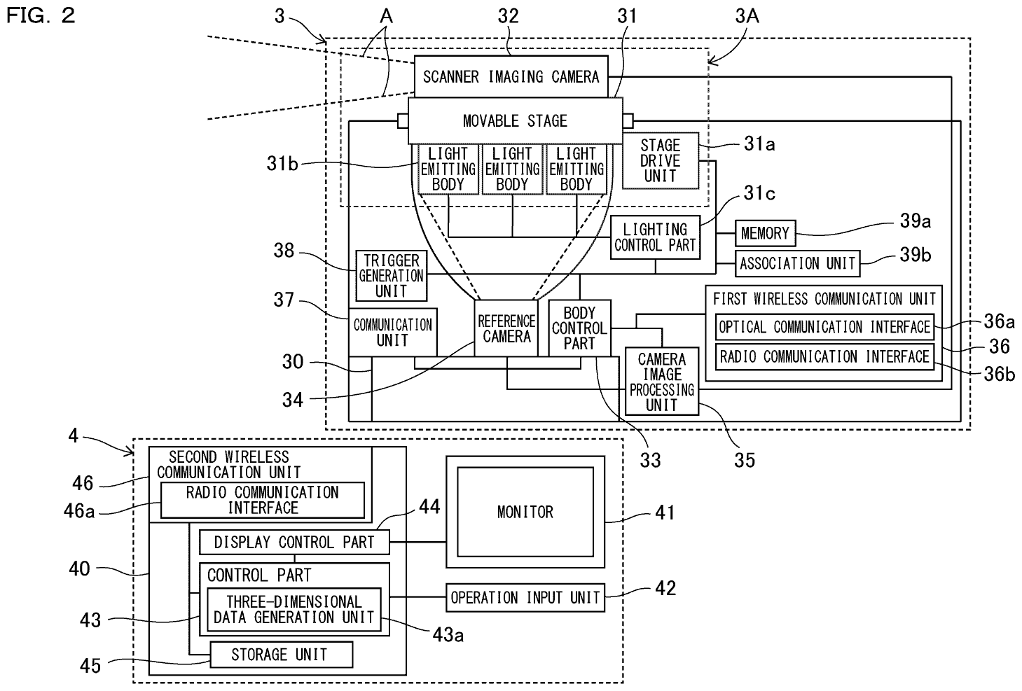

As illustrated in FIG. 2, the imaging unit 3 includes a base 30 and a movable imaging part 3A that moves a field of view such that the three-dimensional scanner 2 is within the field of view, and captures images of scanner markers to measure a position and a posture of the three-dimensional scanner 2 to generate a marker image including the scanner markers. The movable imaging part 3A includes a movable stage 31 supported by the base 30 and a scanner imaging camera 32 fixed to an upper portion of the movable stage 31. The movable stage 31 includes a stage drive unit 31a. The stage drive unit 31a incorporates an actuator such as a motor, and is configured to rotate the movable stage 31 about a left-right axis as well as a vertical axis. Further, the scanner imaging camera 32 rotates about the vertical axis by rotating the movable stage 31 about the vertical axis, and the scanner imaging camera 32 rotates about the left-right axis by rotating the movable stage 31 about the left-right axis. As a result, the scanner marker can be tracked by moving a field of view (schematically indicated by broken lines A in FIGS. 1 and 2) of the scanner imaging camera 32 such that the three-dimensional scanner 2, that is, the plurality of scanner markers provided in the three-dimensional scanner 2, enter the field of view of the scanner imaging camera 32. Similarly, the probe markers of the probe 5 can also be tracked. The stage drive unit 31a is controlled by a body control part 33 provided in the imaging unit 3.

In a lower portion of the movable stage 31, a plurality of light emitting bodies 31b are provided at predetermined intervals on a two-dimensional plane, and the light emitting bodies 31b are switched between a turned-on state and a turned-off state by a lighting control part 31c. Further, arrangement information of each of the light emitting bodies 31b is stored in advance in the imaging unit 3. Note that a member serving as a mark other than the light emitting body may be used. The lighting control part 31c is controlled by the body control part 33. On the other hand, the base 30 is provided with a reference camera 34 that captures an image of the movable imaging part 3A. The reference camera 34 captures an image of the light emitting body 31b turned on by the lighting control part 31c. The reference camera 34 captures images of a plurality of the light emitting bodies 31b provided in the movable imaging part 3A and generates an image including the light emitting bodies 31b.

The imaging unit 3 is provided with a camera image processing unit 35. The camera image processing unit 35 includes an image processing circuit, and controls the scanner imaging camera 32 to execute imaging at a predetermined timing. The scanner imaging camera 32 captures images of scanner markers of the three-dimensional scanner 2 to generate a scanner marker image including the scanner markers. Further, the scanner imaging camera 32 captures images of probe markers of the probe 5 to generate a probe marker image including the probe markers.

Examples of the image processing circuit include a graphics processing unit (GPU), a field programmable gate array (FPGA), a digital signal processor (DSP), and the like. The camera image processing unit 35 receives an input of the scanner marker image or the probe marker image captured by the scanner imaging camera 32 and an input of images of the light emitting bodies 31b captured by the reference camera 34.

The camera image processing unit 35 processes the scanner marker image captured by the scanner imaging camera 32 to generate center position information (corresponding to second measurement information of the invention) of the scanner marker. Specifically, the camera image processing unit 35 performs processing of extracting the center of the scanner marker with respect to the scanner marker image. Then, the center position information of the scanner marker is generated based on an extracted result. Furthermore, the camera image processing unit 35 generates position and posture information of the scanner marker with respect to the movable imaging part 3A based on the center position information of the scanner marker obtained as a result of the processing of extracting the center of the scanner marker.

Further, the camera image processing unit 35 processes the probe marker image captured by the scanner imaging camera 32 to generate center position information (corresponding to third measurement information of the invention) of the probe marker as in the case of the scanner marker. Position and posture information of the scanner marker with respect to the movable imaging part 3A is generated based on the center position information of the scanner marker.

The imaging unit 3 includes a first wireless communication unit 36 that is controlled by the body control part 33. The first wireless communication unit 36 is a communication module or the like configured to be capable of communicating with equipment other than the imaging unit 3. In this example, the imaging unit 3 communicates with the three-dimensional scanner 2 and the probe 5 via the first wireless communication unit 36, thereby enabling, for example, transmission and reception of various types of data such as image data captured by the scanner imaging camera 32, various signals such as a synchronization signal, and the like.

The first wireless communication unit 36 transmits, for example, the synchronization signal to the three-dimensional scanner 2 and the probe 5, and receives measurement information (edge data) generated by a scanner image processing unit 147 described later. Further, the center position information of the scanner marker, which is the measurement information generated by the camera image processing unit 35, and the center position information of the probe marker, which is the measurement information generated by the camera image processing unit 35, are transmitted to the processing unit 4. The first wireless communication unit 36 includes an optical communication interface 36a and a radio communication interface 36b. The optical communication interface 36a is a part configured to perform optical communication using visible light or invisible light, and can be configured by, for example, an infrared communication interface or the like. The radio communication interface 36b may be, for example, a part configured to construct a wireless LAN, or may be a part capable of short-range digital wireless communication using radio waves such as Bluetooth (registered trademark) communication. The optical communication has characteristics that the directivity is high and the time required for information transfer is accurate. For this reason, a trigger signal generated by a trigger generation unit 38 described later may be transmitted from the imaging unit 3 to the three-dimensional scanner 2 by the optical communication. Further, the wireless communication using radio waves has characteristics that it is possible to transmit and receive information having a large data amount although the time required for information transfer is indefinite. Therefore, the edge data, which is the measurement information generated by the scanner image processing unit 147, and the center position information of the scanner marker and the center position information of the probe marker, which are pieces of the measurement information generated by the camera image processing unit 35, may be transmitted and received by the wireless communication using radio waves. Since the three-dimensional scanner 2 and the imaging unit 3 are wirelessly connected to each other in this manner, there is no restriction of a cable or the like, so that the portability of the probe 5 can be enhanced, and a measurement region can be expanded.

The imaging unit 3 also includes a communication unit 37 that is controlled by the body control part 33. The communication unit 37 is a communication module or the like configured to be capable of communicating with the processing unit 4. The imaging unit 3 communicates with the processing unit 4 via the communication unit 37, thereby enabling, for example, transmission and reception of various types of data such as image data and various signals. The communication by the communication unit 37 may be wired communication or wireless communication.

The imaging unit 3 includes the trigger generation unit (corresponding to a synchronization mechanism of the invention) 38 that generates identification information for identifying a synchronous execution timing based on a measurement instruction. For example, when the measurement worker performs a predetermined measurement start operation, the body control part 33 of the imaging unit 3 receives the measurement start operation. When receiving the measurement start operation, the body control part 33 causes the trigger generation unit 38 to generate a trigger as the above-described identification information. The trigger is transmitted to the three-dimensional scanner 2 via the optical communication interface 36a of the first wireless communication unit 36, for example. In the case of using the probe 5, the trigger is transmitted to the probe 5 via the optical communication interface 36a. The optical communication has characteristics that the directivity is high and the time required for information transfer is accurate, and the time from a timing at which the imaging unit 3 transmits the trigger signal to the imaging unit 3 or the probe 5 until the imaging unit 3 or the probe 5 receives the trigger signal is constant. Therefore, imaging of the scanner imaging camera 32 and light emission of the scanner markers or the probe markers can be strictly synchronized. As a result, a light emission time of the self-luminous markers can be shortened, and heat generated inside a scanner body 20 by the light emission of the self-luminous markers can be suppressed.

In response to the generation of the trigger, the body control part 33 synchronously executes light emission of the scanner markers of the three-dimensional scanner 2, imaging of the scanner markers of the three-dimensional scanner 2 by the movable imaging part 3A, lighting of the light emitting bodies 31b of the movable stage 31, and imaging of the light emitting bodies 31b by the reference camera 34. Note that the light emitting bodies 31b of the movable stage 31 may be constantly turned on. Therefore, the body control part 33 executes at least the light emission of the scanner markers of the three-dimensional scanner 2, the imaging by the movable imaging part 3A, and the imaging by the reference camera 34 in synchronization. A timing of the light emission of the scanner markers of the three-dimensional scanner 2 may be slightly earlier than a timing of the imaging by the movable imaging part 3A. In this case as well, it is assumed that the light emission of the scanner markers of the three-dimensional scanner 2 is synchronized with the imaging by the movable imaging part 3A.

The radio communication interface 36b of the first wireless communication unit 36 transmits the center position information of the scanner marker generated by the camera image processing unit 35 and the identification information that is generated by the trigger generation unit 38 and corresponds to the center position information of the scanner marker to be tied to each other. The term “tying” means linking or associating two or more pieces of information. In this case, the center position information of the scanner marker is linked to the identification information for distinguishing the center position information of the scanner marker from center position information of another scanner marker. Thus, center position information of a desired scanner marker can be specified based on the identification information. Note that the center position information of the scanner marker and the identification information may be transmitted by wireless communication.

### Configuration of Processing Unit 4

The processing unit 4 is a three-dimensional data generation unit that receives positions and postures of a plurality of markers obtained by processing the scanner marker image generated by the imaging unit 3 from the imaging unit 3, receives edge data of the bright line image obtained by processing the bright line image generated by the three-dimensional scanner 2, and measures a three-dimensional shape of the measurement target W based on the received positions and postures of the scanner markers and the edge data.

As a technique for measuring the three-dimensional shape, a conventionally known technique can be used. Hereinafter, an example will be described. Since the plurality of light emitting bodies 31b of the imaging unit 3 are provided on the movable stage 31 to which the scanner imaging camera 32 is fixed, a positional relationship of the plurality of light emitting bodies 31b with respect to the scanner imaging camera 32 is known. When the scanner imaging camera 32 is moved by the stage drive unit 31a, the scanner imaging camera 32 moves within a range in which images of the light emitting bodies 31b can be captured by the reference camera 34. A position and a posture of the three-dimensional scanner 2 with respect to the scanner imaging camera 32 are determined based on the scanner marker image of the three-dimensional scanner 2 captured by the scanner imaging camera 32.

Further, the reference camera 34 similarly determines a position and a posture of the scanner imaging camera 32 with respect to the reference camera 34 based on the images obtained by capturing the plurality of light emitting bodies 31b. Specifically, the camera image processing unit 35 processes the images of the light emitting bodies 31b generated by the reference camera 34 to generate position and posture information of the scanner imaging camera 32 with respect to the reference camera 34.

A position and a posture of the three-dimensional scanner 2 with respect to the reference camera 34 are determined from the position and posture of the three-dimensional scanner 2 with respect to the scanner imaging camera 32 and the position and posture of the scanner imaging camera 32 with respect to the reference camera 34, and coordinates of a measurement point are obtained, so that three-dimensional coordinate measurement, that is, three-dimensional shape measurement becomes possible.

FIG. 1 illustrates an example in which the processing unit 4 is configured by a general-purpose notebook personal computer. However, the processing unit 4 may be configured by a desktop personal computer, a controller dedicated to the three-dimensional measurement device 1, or the like. In any case, the processing unit 4 can be used by installing a program or an application for implementing functions of the three-dimensional measurement device 1. The processing unit 4 may be provided separately from the imaging unit 3 or may be integrated with the imaging unit 3. Further, a part of the processing unit 4 may be incorporated in the imaging unit 3, or a part of the imaging unit 3 may be incorporated in the processing unit 4.

As illustrated in FIG. 2, the processing unit 4 includes a control unit 40, a monitor 41, and an operation input unit 42. The monitor 41 is configured by a liquid crystal display, an organic EL display, or the like configured to be capable of displaying various images, a user interface, and the like.

The operation input unit 42 is a part by which a user performs various input operations. The operation input unit 42 includes, for example, a keyboard, a mouse, and the like.

The control unit 40 includes a control part 43, a display control part 44, a storage unit 45, and a second wireless communication unit 46. The display control part 44 is a part that controls the monitor 41 based on a signal output from the control part 43, and causes the monitor 41 to display various images, a user interface, and the like. The user's operation performed on the user interface is acquired by the control part 43 based on a signal output from the operation input unit 42.

The storage unit 45 may be a ROM, a solid state drive, a hard disk drive, or the like. The storage unit 45 stores arrangement information of each of scanner markers in marker blocks provided in the three-dimensional scanner 2. The arrangement information of the marker block and each of the scanner markers includes a distance between the marker blocks, information indicating a relative positional relationship of the self-luminous markers provided in each of the marker blocks, and the like.

Further, the second wireless communication unit 46 of the processing unit 4 is controlled by the control part 43. The second wireless communication unit 46 is a communication module or the like configured to be capable of communicating with the first wireless communication unit 36 of the imaging unit 3. The second wireless communication unit 46 includes a radio communication interface 46a. The radio communication interface 46a of the second wireless communication unit 46 receives the edge data which is the measurement information transmitted via the radio communication interface 36b of the first wireless communication unit 36 of the imaging unit 3, the center position information of the scanner marker, and the center position information of the probe marker. The wireless communication using radio waves has characteristics that it is possible to transmit and receive information having a large data amount although the time required for information transfer is indefinite. Therefore, such measurement information may be transmitted via the radio communication interface 46a of the second wireless communication unit 46.

### Configuration of Three-Dimensional Scanner 2

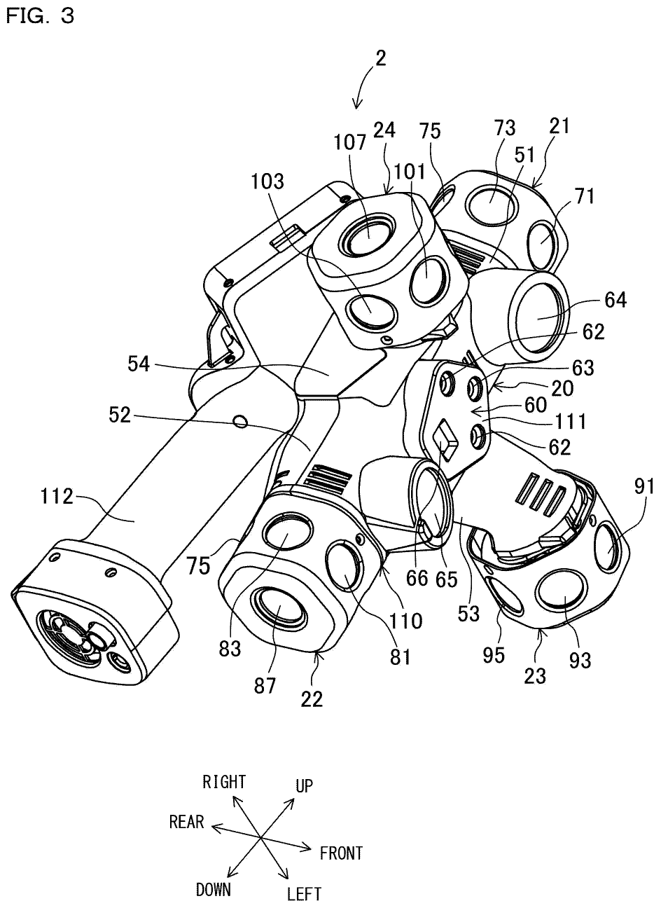

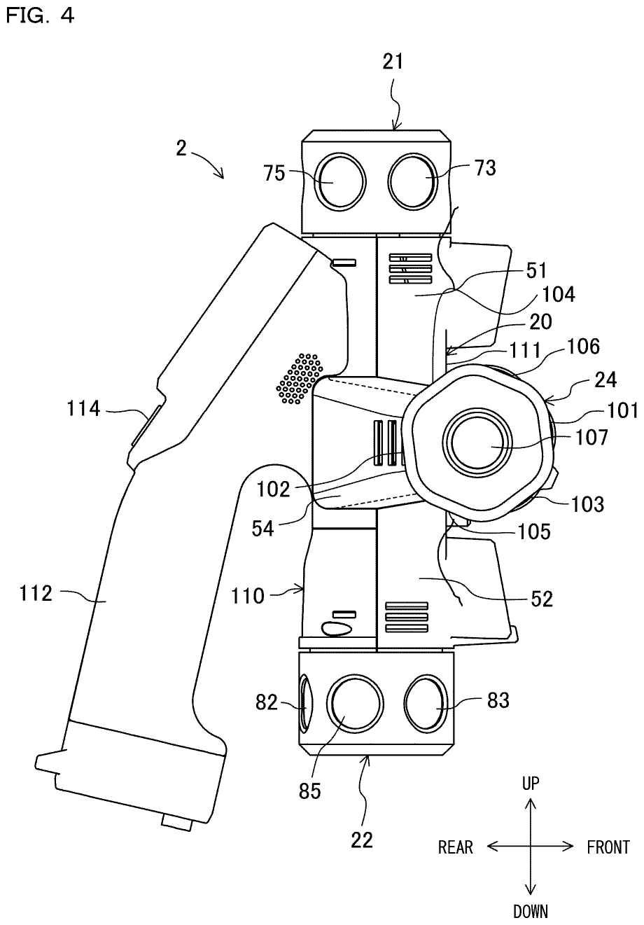

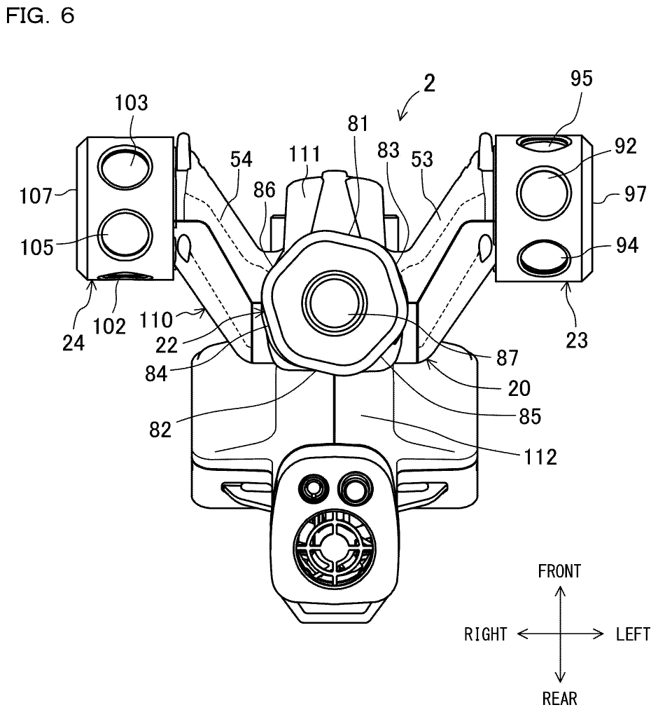

The three-dimensional scanner 2 is configured such that the measurement worker can measure the shape of the measurement target W while holding and freely moving the three-dimensional scanner 2 with one hand or both hands, and is a handheld and portable scanner. Power may be supplied from the outside, or supplied from a built-in battery. In the present embodiment, the front, rear, left, right, up, down of the three-dimensional scanner 2 are defined as illustrated in FIGS. 3 to 7. That is, when the measurement worker holds the three-dimensional scanner 2 by hand, a side located on the right is referred to as the right, and a side located on the left is referred to as the left. The front of the three-dimensional scanner 2 is a side opposing the measurement target W, and the rear side of the three-dimensional scanner 2 is a side opposite to the side opposing the measurement target W. The up of the three-dimensional scanner 2 is a side on the upper side in a state where a grip part 112, which will be described later, is gripped in a natural posture as determined, and the down of the three-dimensional scanner 2 is a side on the lower side in a state where the grip part 112 is gripped in the natural posture as determined. However, since the three-dimensional shape of the measurement target W can be measured while the three-dimensional scanner 2 is held and moved by hand as described above, the three-dimensional scanner 2 may have an orientation of being inverted upside down or a posture in which the upper side is located on the right or left, or the rear side thereof may be located at the up or down.

The three-dimensional scanner 2 includes the scanner body 20, a first marker block 21, a second marker block 22, a third marker block 23, and a fourth marker block 24. Although details will be described later, the first to fourth marker blocks 21 to 24 each have self-luminous scanner markers facing a plurality of directions, respectively.

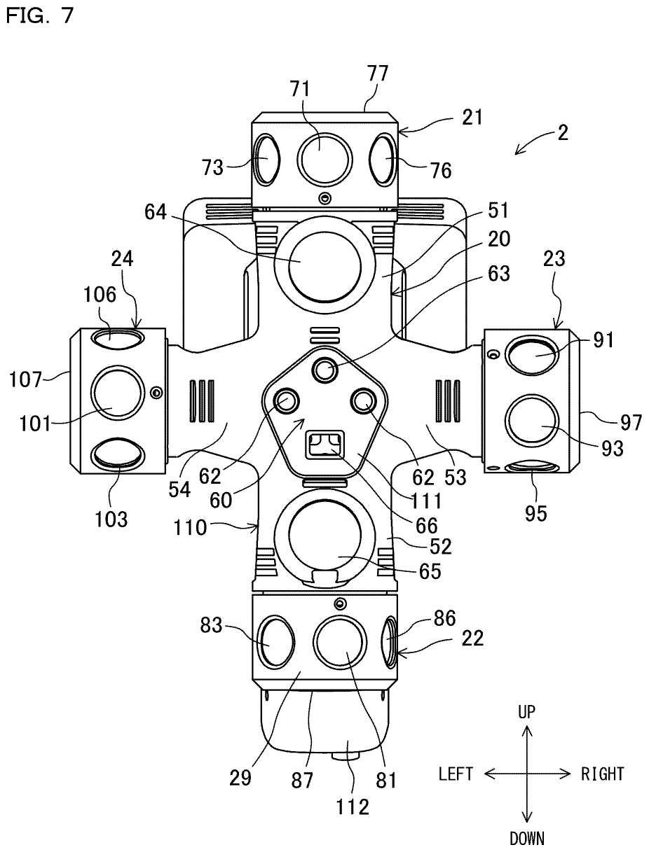

As illustrated in FIG. 7, the scanner body 20 includes a first arm part 51 extending upward from a central portion, a second arm part 52 extending downward from the central portion, a third arm part 53 extending leftward from the central portion, and a fourth arm part 54 extending rightward from the central portion. The first marker block 21 is attached to a distal end of the first arm part 51, the second marker block 22 is attached to a distal end of the second arm part 52, the third marker block 23 is attached to a distal end of the third arm part 53, and the fourth marker block 24 is attached to a distal end of the fourth arm part 54.

The first marker block 21 and the second marker block 22 are spaced apart from each other in the up-down direction, and the scanner unit 60 is arranged at the central portion between the first marker block 21 and the second marker block 22. Therefore, the first marker block 21 and the second marker block 22 constitute a pair of marker blocks arrayed side by side in the up-down direction in a state where the scanner unit 60 is positioned at the center.

Further, the third marker block 23 and the fourth marker block 24 are spaced apart from each other in the left-right direction, and the scanner unit 60 is arranged at the central portion between the third marker block 23 and the fourth marker block 24. Therefore, the third marker block 23 and the fourth marker block 24 constitute a pair of marker blocks arrayed side by side in the left-right direction in a state where the scanner unit 60 is positioned at the center.

The scanner body 20 includes the scanner unit 60. The scanner unit 60 includes two first scanner light sources 62, a second scanner light source 63, a first scanner imaging part 64, a second scanner imaging part 65, and a texture camera 66. The two first scanner light sources 62 are multi-line light sources each emitting a plurality of linear light beams in a measurement direction (forward), and are arranged such that light emission surfaces oppose the measurement target W at the time of measurement. The light emitted by the first scanner light source 62 can be referred to as multi-line light, and the multi-line light is included in pattern light.

The second scanner light source 63 is attached above the first scanner light sources 62. The second scanner light source 63 is a single-line light source that emits one linear light beam in the measurement direction (forward), and is arranged such that a light emission surface opposes the measurement target W at the time of measurement. The light emitted by the second scanner light source 63 can be referred to as single-line light, and the single-line light is also included in the pattern light.

Each of the first scanner light sources 62 and the second scanner light source 63 includes the laser light source that emits the laser light, but a type of the light source is not particularly limited. Further, a total of three scanner light sources 62 and 63 are provided in this example, but the invention is not limited thereto, and one or more scanner light sources may be provided. Further, a type of the pattern light is not particularly limited, and the scanner light source may emit pattern light other than the multi-line light and the single-line light.

The first scanner imaging part 64 and the second scanner imaging part 65 include, for example, a light receiving element such as a CMOS sensor, an optical system for forming an image of light incident from the outside on a light receiving surface of the light receiving element, and the like. The first scanner imaging part 64 is attached to a portion spaced upward from the scanner light sources 62 and 63. The second scanner imaging part 65 is attached to a portion spaced downward from the scanner light sources 62 and 63. The first scanner imaging part 64 and the second scanner imaging part 65 are arranged such that optical axes thereof are oriented in irradiation directions of beams of the pattern light from the scanner light sources 62 and 63, respectively, and accordingly, it is possible to capture images of beams of the pattern light emitted from the scanner light sources 62 and 63 in the measurement direction and generate the bright line image (corresponding to a first image of the invention) including the pattern light.

Since the first scanner imaging part 64 is attached above the scanner light sources 62 and 63 and the second scanner imaging part 65 is attached below the scanner light sources 62 and 63, it is possible to secure a long distance between the first scanner imaging part 64 and the second scanner imaging part 65 and to enhance the accuracy of a stereo measurement method. That is, a distance between the optical axes of the first scanner imaging part 64 and the second scanner imaging part 65 is known, a corresponding point between the respective images generated by simultaneously capturing the pattern light emitted from the first scanner light source 62 or the second scanner light source 63 by the first scanner imaging part 64 and the second scanner imaging part 65 is obtained, and three-dimensional coordinates of the corresponding point can be obtained using the stereo measurement method. The stereo measurement method may be passive stereo using the first scanner imaging part 64 and the second scanner imaging part 65, or may be active stereo using one scanner imaging part. In particular, there is a case where the pattern light is not included in one of the images generated by the first scanner imaging part 64 and the second scanner imaging part 65, such as a case where the measurement target W is specularly reflected or a case where a deep hole is measured. In such a case, the three-dimensional coordinates may be calculated by an active stereo method based on a positional relationship between the scanner imaging part and the scanner light source corresponding to the image obtained by capturing the pattern light.

The texture camera 66 includes, for example, a light receiving element such as a CMOS sensor capable of acquiring a color image, an optical system for forming an image of light incident from the outside on a light receiving surface of the light receiving element, and the like. The texture camera 66 is provided between the first scanner imaging part 64 and the second scanner imaging part 65. The texture camera 66 is arranged such that an optical axis is oriented toward the measurement target W at the time of measurement, and captures an image of the measurement target W to generate a texture image.

The first marker block 21 includes first to seventh scanner markers 71 to 77 facing a plurality of directions. The first to seventh scanner markers 71 to 77 all have the same structure and include a light emitting diode (LED). The second to fourth marker blocks 22 to 24 are configured similarly to the first marker block 21. That is, as illustrated in FIGS. 3 to 7, the second marker block 22 includes first to seventh scanner markers 81 to 87, the third marker block 23 includes first to seventh scanner markers 91 to 97, and the fourth marker block 24 includes first to seventh scanner markers 101 to 107.

The scanner body 20 includes an exterior member 110. A front part of the exterior member 110 includes a scanner cover part 111 that covers the first scanner light source 62, the second scanner light source 63, the first scanner imaging part 64, and the second scanner imaging part 65. Further, a rear part of the exterior member 110 has the grip part 112 to be gripped by the measurement worker.

A display unit 113 for displaying a measurement result obtained by the scanner unit 60 and an operation unit 114 configured to operate the scanner unit 60 are provided at an upper end of the grip part 112. The display unit 113 is configured by a liquid crystal display, an organic EL display, or the like. Further, a display surface is oriented toward a measurement subject so as to be capable of moving the three-dimensional scanner 2 while viewing a display content of the display unit 113.

A touch panel 113a on which a touch operation can be performed is also provided on the display surface side of the display unit 113. The operation unit 114 includes, for example, a plurality of operation buttons including a measurement start button, a measurement stop button, and the like, and is arranged below the display unit 113. The touch panel 113a can also be a part of the operation unit.

As illustrated in FIG. 1, the three-dimensional measurement device 1 may include a battery unit 90 that is portable and configured to supply power to the three-dimensional scanner 2. Being portable means the possibility of being held, shouldered, attached to the waist, or carried on the back by the measurement worker. The battery unit 90 has a primary battery or a secondary battery, and is configured to be replaceable in the case of the primary battery, and can be charged via an adapter (not illustrated) in the case of the secondary battery. A power supply line 91 is connected to the battery unit 90. The three-dimensional scanner 2 has a power supply port 92 that receives power supply from the battery unit 90. A distal end of the power supply line 91 is connected to the power supply port 92. Since the battery unit 90 is provided, the three-dimensional scanner 2 is more easily handled, and measurement workability is improved.

### Circuit of Three-Dimensional Scanner 2

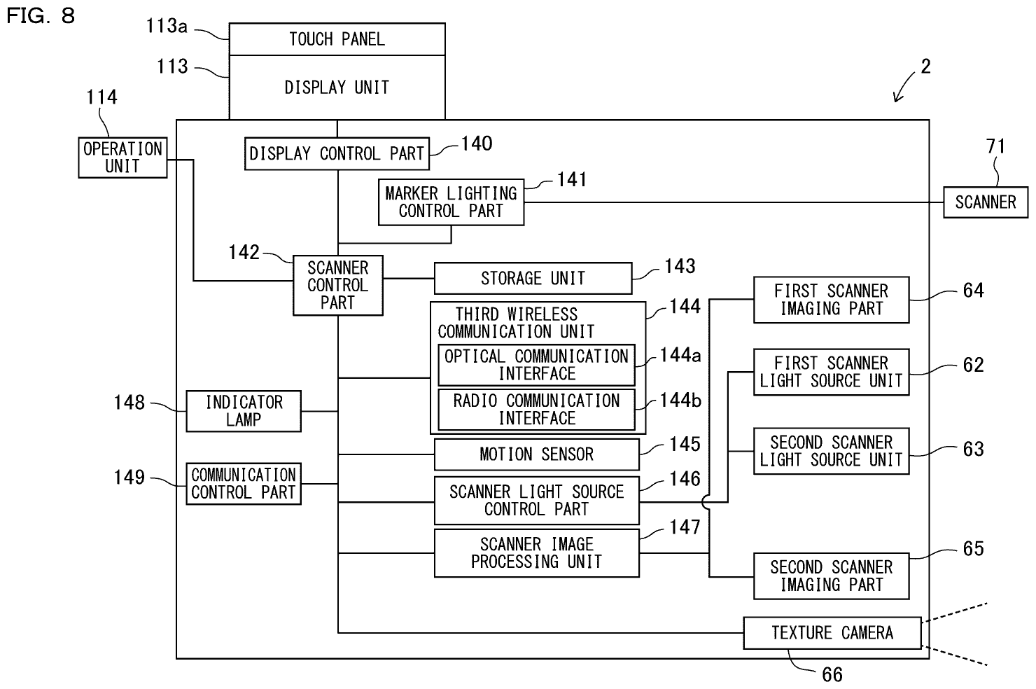

Next, a circuit of the three-dimensional scanner 2 will be described with reference to FIG. 8. The three-dimensional scanner 2 includes a display control part 140, a marker lighting control part 141, a scanner control part 142, and a storage unit 143. The display control part 140 is a part that controls the display unit 113 based on a signal output from the scanner control part 142, and causes the display unit 113 to display various images, a user interface, and the like. The user's operation performed on the display unit 113 is acquired by the scanner control part 142 based on a signal output from the touch panel 113a.

The marker lighting control part 141 is a part that controls the scanner markers 71 to 77, 81 to 87, 91 to 97, and 101 to 107 (only 71 is illustrated in FIG. 8). The scanner markers 71 to 77, 81 to 87, 91 to 97, and 101 to 107 are switched between the turned-on state and the turned-off state by the marker lighting control part 141. The marker lighting control part 141 is controlled by the scanner control part 142. The storage unit 143 can temporarily store a program, an image captured by the scanner unit 60, and the like.

The three-dimensional scanner 2 includes a third wireless communication unit 144 that is controlled by the scanner control part 142. The third wireless communication unit 144 is a communication module or the like configured to be capable of communicating with equipment other than the three-dimensional scanner 2. The third wireless communication unit 144 is a part configured to transmit the edge data generated by the scanner image processing unit 147 to the first wireless communication unit 36 of the imaging unit 3, and receive the synchronization signal transmitted from the first wireless communication unit 36. The third wireless communication unit 144 includes an optical communication interface 144a and a radio communication interface 144b.

The three-dimensional scanner 2 includes a motion sensor 145. The motion sensor 145 includes a sensor that detects an acceleration and an angular velocity of the three-dimensional scanner 2, and detected values are output to the scanner control part 142 and used for various types of calculation processing. For example, a value output from the motion sensor 145 can be used to obtain an initial solution of the posture of the three-dimensional scanner 2, that is, the postures of the first to fourth marker blocks 21 to 24, thereby improving the matching accuracy and improving the processing speed at the time of posture calculation. The processing using the values output from the motion sensor 145 may be executed by the imaging unit 3 or the processing unit 4.

The three-dimensional scanner 2 includes a scanner light source control part 146 and the scanner image processing unit 147. The scanner light source control part 146 controls the first scanner light source 62 and the second scanner light source 63. The first scanner light source 62 and the second scanner light source 63 are switched between the turned-on state and the turned-off state by the scanner light source control part 146. The scanner light source control part 146 is controlled by the scanner control part 142. Further, the scanner image processing unit 147 controls the first scanner imaging part 64, the second scanner imaging part 65, and the texture camera 66 to execute imaging at a predetermined timing. Images captured by the first scanner imaging part 64, the second scanner imaging part 65, and the texture camera 66 are input to the scanner image processing unit 147. The scanner image processing unit 147 executes various types of image processing such as extraction of edge data on the input images.

That is, the scanner image processing unit 147 generates edge data (corresponding to first measurement information of the invention) by performing edge extraction processing on the bright line image generated by the first scanner imaging part 64 or the second scanner imaging part 65. In a case where the first scanner light sources 62 emit the multi-line light, the first scanner imaging part 64 and the second scanner imaging part 65 generate multi-line images. The scanner image processing unit 147 processes the multi-line images to generate the edge data.

The third wireless communication unit 144 transmits the edge data generated by the scanner image processing unit 147 and identification information corresponding to the edge data generated by the trigger generation unit 38 to be tied to each other. That is, the edge data and the identification information for distinguishing the edge data from another edge data are linked to each other. Therefore, it is possible to specify desired edge data based on the identification information.

Further, when the trigger generated by the trigger generation unit 38 of the imaging unit 3 is transmitted to the three-dimensional scanner 2, the three-dimensional scanner 2 receives the trigger as the synchronization signal via the optical communication interface 144a of the third wireless communication unit 144. When the trigger is received, the scanner light source control part 146 executes emission of pattern light from the first scanner light sources 62 or the second scanner light source 63, the scanner image processing unit 147 executes imaging by the first scanner imaging part 64 and the second scanner imaging part 65, and the marker lighting control part 141 causes the scanner markers 71 to 77, 81 to 87, 91 to 97, and 101 to 107 to emit light. The emission of pattern light from the first scanner light sources 62 or the second scanner light source 63, the imaging by the first scanner imaging part 64 and the second scanner imaging part 65, and the light emission of the scanner markers 71 to 77, 81 to 87, 91 to 97, and 101 to 107 are synchronized with each other.

In short, the body control part 33 of the imaging unit 3 and the scanner control part 142 of the three-dimensional scanner 2 cooperate to synchronize the emission of pattern light from the scanner light sources 62 or 63, the imaging by the scanner imaging parts 64 and 65, the light emission of the scanner markers 71 to 77, 81 to 87, 91 to 97, and 101 to 107, and the imaging by the movable imaging part 3A in response to the generation of the trigger by the trigger generation unit 38. Therefore, the body control part 33 and the scanner control part 142 constitute a measurement control part of the invention. Note that the emission of pattern light from the scanner light sources 62 or 63, the imaging by the scanner imaging parts 64 and 65, the light emission of the scanner markers 71 to 77, 81 to 87, 91 to 97, and 101 to 107, and the imaging by the movable imaging part 3A may be synchronized by one measurement control part.

The three-dimensional scanner 2 transmits the edge data generated by the scanner image processing unit 147 to the imaging unit 3 via the radio communication interface 144b of the third wireless communication unit 144. The imaging unit 3 receives the edge data via the radio communication interface 36b of the first wireless communication unit 36, and transmits the received edge data and the center position information of the scanner marker generated by the camera image processing unit 35 to the second wireless communication unit 46 of the processing unit 4.

The three-dimensional scanner 2 includes an indicator lamp 148 and the communication control part 149. The indicator lamp 148 displays an operation state of the three-dimensional scanner 2, and is controlled by the scanner control part 142. The communication control part 149 is a part that performs processing of executing communication of, for example, image data and the like.

### Contact-Type Probe

The contact-type probe 5 is a handheld or portable probe similarly to the three-dimensional scanner 2. As illustrated in FIG. 1, the probe 5 includes a probe body 120 and a stylus 121 protruding from the probe body 120. A contact 121a configured to make contact with the measurement target W is provided at a tip of the stylus 121. The contact 121a has, for example, a spherical shape. The contact 121a is a part configured to indicate a position of a measurement point of the measurement target W. Further, the probe body 120 has a grip part 5A at an intermediate part thereof in the longitudinal direction, and a measurement worker can grip the grip part 5A with one hand and move the probe 5 or change the orientation at the time of measurement.

The probe body 120 is provided with a plurality of probe markers 5B spaced apart from each other. For example, a plurality of probe markers 5B are spaced apart from each other on one end side of the probe body 120 in the longitudinal direction, and a plurality of probe markers 5B are also spaced apart from each other on the other end side of the probe body 120 in the longitudinal direction.

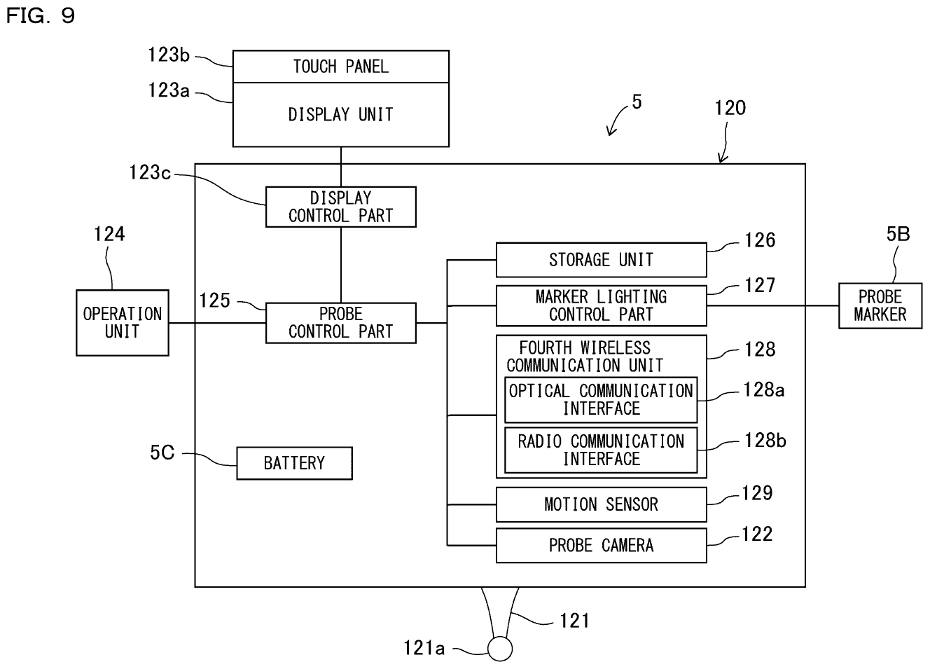

FIG. 9 illustrates a circuit configuration of the probe 5. Although only one probe marker 5B is illustrated in FIG. 9, the plurality of probe markers 5B are provided in practice. A probe camera 122 is provided in the vicinity of the stylus 121. The probe 5 includes a display unit 123a configured by a liquid crystal display, an organic EL display, or the like, a touch panel 123b that is operated by a touch, and a display control part 123c. Further, an operation unit 124 including a plurality of buttons and the like is provided in the vicinity of the display unit 123a. The probe 5 further includes a probe control part 125, a storage unit 126, a probe marker lighting control part 127, a fourth wireless communication unit 128, a motion sensor 129, and the like. Further, the probe 5 also includes a battery 5C serving as a power source.

The display control part 123c is a part that controls the display unit 123a based on a signal output from the probe control part 125, and causes the display unit 123a to display various images, a user interface, and the like. The user's operation performed on the display unit 123a is acquired by the probe control part 125 based on a signal output from the touch panel 123b.

The probe marker lighting control part 127 is a part that controls the probe marker 5B. The probe marker 5B is switched between a turned-on state and a turned-off state by the probe marker lighting control part 127. The probe marker lighting control part 127 is controlled by the probe control part 125. A program and the like can be stored in the storage unit 126.

Similarly to the first wireless communication unit 36 of the imaging unit 3, the fourth wireless communication unit 128 includes an optical communication interface 128a and a radio communication interface 128b. The optical communication interface 128a is a part that receives the trigger transmitted via the optical communication interface 36a of the imaging unit 3. When the trigger is received, the probe marker lighting control part 127 turns on the probe marker 5B. As a result, imaging of the probe marker by the imaging unit 3 and lighting of the probe marker 5B can be synchronized. The radio communication interface 128b may have a radio communication system different from that of the radio communication interface 144b of the three-dimensional scanner 2, and for example, when the radio communication interface 144b of the three-dimensional scanner 2 constructs a wireless LAN, the radio communication interface 128b of the fourth wireless communication unit 128 can be configured as a part capable of Bluetooth communication or the like having a communication speed lower than that of the wireless LAN. Note that, when the radio communication system is different between the radio communication interface 144b of the three-dimensional scanner 2 and the radio communication interface 128b of the probe 5 in this manner, the radio communication interface 36b of the imaging unit 3 may support both the radio communication interface 144b of the three-dimensional scanner 2 and the radio communication interface 128b of the probe 5. That is, when the radio communication interface 144b of the three-dimensional scanner 2 constructs a wireless LAN and the radio communication interface 128b of the probe 5 constructs Bluetooth communication, the radio communication interface 36b of the imaging unit 3 may support both the wireless LAN and the Bluetooth communication.

Transmission and reception of data between the probe 5 and the imaging unit 3 has a smaller data amount than transmission and reception of data between the three-dimensional scanner 2 and the imaging unit 3 that continuously transmit measurement data. Therefore, the radio communication constructed between the probe 5 and the imaging unit 3 may use Bluetooth communication that consumes less power and is expected to have a long battery life.

The motion sensor 129 includes a sensor that detects an acceleration and an angular velocity of the probe 5, and detected values are output to the probe control part 125 and used for various types of calculation processing such as posture calculation of the probe 5, similarly to the posture calculation of the three-dimensional scanner 2.

### Three-Dimensional Data Generation Unit

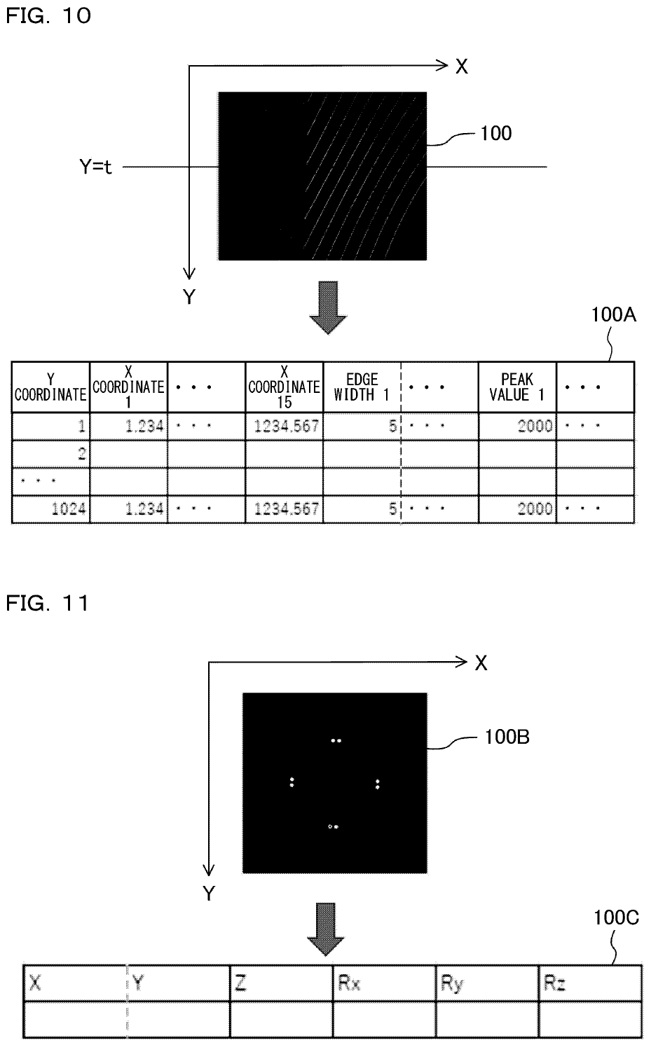

The processing unit 4 includes a three-dimensional data generation unit 43a. That is, when the processing unit 4 receives the center position information of the scanner marker generated by the camera image processing unit 35 via the second wireless communication unit 46 at the time of measurement by the three-dimensional scanner 2, the three-dimensional data generation unit 43a generates a point cloud indicating the three-dimensional shape of the measurement target W based on the edge data generated by the scanner image processing unit 147, the center position information of the scanner marker generated by the camera image processing unit 35, and the position and posture information of the scanner imaging camera 32. An image 100 on the upper side in FIG. 10 illustrates an example of the multi-line images generated by the first scanner imaging part 64 and the second scanner imaging part 65. A table 100A on the lower side in FIG. 10 illustrates an example of the edge data generated by processing the multi-line images by the scanner image processing unit 147. Further, an image 100B on the upper side in FIG. 11 illustrates an example of the scanner marker image generated by the scanner imaging camera 32. A table 100C on the lower side in FIG. 11 illustrates an example of the center position information generated by processing the scanner marker image by the camera image processing unit 35.

As illustrated in the tables 100A and 100C, it is possible to compress image data and transmit necessary information by transmitting the edge data instead of the images captured by the scanner imaging parts 64 and 65 and transmitting the center position information of each of the self-luminous markers instead of the image captured by the scanner imaging camera 32. Further, subpixel processing is performed in the edge data extraction processing so that not only the image data can be compressed, but also more accurate data can be transmitted. Note that, in a case where three-dimensional coordinates are calculated by a passive stereo method, each of first edge data calculated from the pattern image generated by the first scanner imaging part 64 and second edge data calculated from the pattern image generated by the second scanner imaging part 65 can be transmitted with the same assigned identification information.

Here, the edge data is calculated for each of the multi-line images generated by the first scanner imaging part 64 and the second scanner imaging part 65. The edge data is calculated by specifying a change in a luminance value for each Y coordinate of the multi-line image and performing arithmetic processing such as differential processing on the change in the luminance value. That is, the edge data is data indicating a position (X coordinate) of a bright line in each Y coordinate. In the example illustrated in FIG. 10, for each Y coordinate, X coordinates (peak positions) of fifteen points from X coordinate 1 to X coordinate 15 as peaks of the luminance value are calculated. Further, an edge width is a peak width of the luminance value, and the peak value is a peak height at each X coordinate. The edge width and the peak value can also be referred to as reliability information, and are used for three-dimensional coordinate calculation to be described later. In this manner, the edge data including the peak position in each Y coordinate and the reliability information is generated from the multi-line image, and pieces of the edge data generated from the multi-line images, respectively, are transmitted to the three-dimensional data generation unit 43a.

Further, the center position information of each of the self-luminous markers 71 to 77, 81 to 87, 91 to 97, and 101 to 107 is generated by the following method. First, the camera image processing unit 35 acquires the arrangement information of each of the self-luminous markers 71 to 77, 81 to 87, 91 to 97, and 101 to 107 from the storage unit 143 of the three-dimensional scanner 2. Then, the camera image processing unit 35 calculates any position at which an image of each of the markers is captured by the imaging unit 3 when a relative position or posture of the three-dimensional scanner 2 with respect to the imaging unit 3 is changed based on the arrangement information of the self-luminous markers 71 to 77, 81 to 87, 91 to 97, and 101 to 107 acquired from the storage unit 143 of the three-dimensional scanner 2 and relative three-dimensional position information between the markers included in the marker image generated by the camera image processing unit 35, and matches the calculated position of each of the markers with a marker position of an image 102. Then, a relative position and posture of the three-dimensional scanner 2 with respect to the imaging unit 3 in which an error between the calculated position of each of the markers and the marker position of the image 102 is minimized are calculated and generated as the center position information of each of the self-luminous markers 71 to 77, 81 to 87, 91 to 97, and 101 to 107 illustrated in Table 100C. That is, the camera image processing unit 35 virtually changes the arrangement information of each of the self-luminous markers 71 to 77, 81 to 87, 91 to 97, and 101 to 107 acquired from the storage unit 143 of the three-dimensional scanner 2 by virtually changing the position and posture of the three-dimensional scanner 2, calculates a position and a posture matching the marker image generated by the camera image processing unit 35, and generates the center position information of each of the self-luminous markers 71 to 77, 81 to 87, 91 to 97, and 101 to 107. This position and posture information calculation processing may be called bundle adjustment. Here, for the matching, some of the self-luminous markers 71 to 77, 81 to 87, 91 to 97, and 101 to 107 included in the marker image may be selectively used representative markers. The circular self-luminous markers 71 to 77, 81 to 87, 91 to 97, and 101 to 107 have an elliptical shape depending on the position and posture of the three-dimensional scanner 2. In this regard, as an example, an oblateness that is a ratio of lengths of a long side and a short side of each of the self-luminous markers 71 to 77, 81 to 87, 91 to 97, and 101 to 107 included in the marker image may be used to set the self-luminous markers 71 to 77, 81 to 87, 91 to 97, and 101 to 107 having the oblateness equal to or more than the predetermined value as representative markers while excluding a case where the oblateness is equal to or less than a predetermined value from calculation targets. Further, one close to a perfect circle in a marker block may be selected as a representative marker. As the self-luminous marker set as the calculation target is limited to the representative marker in this manner, it is possible to improve calculation speed and to suppress a decrease in measurement accuracy.

The center position information of each of the self-luminous markers 71 to 77, 81 to 87, 91 to 97, and 101 to 107 calculated here uses the scanner imaging camera 32 as a reference. In this regard, the camera image processing unit 35 calculates position and posture information of the three-dimensional scanner 2 using the reference camera 34 as a reference based on position and posture information of the scanner imaging camera 32 using the reference camera 34 as a reference and the position and posture information of the three-dimensional scanner 2 using the scanner imaging camera 32 as a reference, thereby generating the center position information of the self-luminous marker using the reference camera 34 as a reference.

Note that a value output from the motion sensor 145 at the time of generating the center position information of the self-luminous markers 71 to 77, 81 to 87, 91 to 97, and 101 to 107 can be used to obtain an initial solution of the posture of the three-dimensional scanner 2, that is, the postures of the first to fourth marker blocks 21 to 24, thereby improving the matching accuracy and improving the processing speed at the time of posture calculation.

When imaging is executed, the three-dimensional data generation unit 43a receives edge data generated by the scanner image processing unit 147, identification information corresponding to the edge data, center position information of each of the scanner markers generated by the camera image processing unit 35, and identification information corresponding to the center position information of each of the scanner markers. Further, the three-dimensional data generation unit 43a may acquire calibration data from the storage unit 143 of the three-dimensional scanner 2 in advance, and store the acquired calibration data in the storage unit 45 of the processing unit 4. Then, the three-dimensional data generation unit 43a generates a point cloud indicating a three-dimensional shape of the measurement target W based on the edge data, the identification information corresponding to the edge data, the center position information of each of the scanner markers, the identification information corresponding to the center position information of each of the scanner markers, and the calibration data of the three-dimensional scanner 2 stored in the storage unit 45 of the processing unit 4.

The three-dimensional data generation unit 43a may use the reliability information included in the edge data when generating the point cloud indicating the three-dimensional shape of the measurement target W. That is, it may be determined whether each set of coordinates of (X, Y) is a valid value or an invalid value based on the magnitude of the edge width or the peak value which is the reliability information, and the point cloud may be generated using a set of coordinates determined to be the valid value.

Specifically, the processing unit 4 first specifies a corresponding point between the first edge data and the second edge data generated by the camera image processing unit 35. That is, for each set of coordinates of (X, Y) included in the first edge data, corresponding coordinates are specified from sets of coordinates of (X, Y) included in the second edge data. Here, matching between each set of coordinates is performed in a three-dimensional space. Note that edge data of one may be projected onto a pattern image of the other, and the closest edge data may be specified as the corresponding point. Then, coordinates are calculated by the triangulation using a corresponding set of coordinates between the first edge data and the second edge data. This coordinate calculation is executed for each set of coordinates included in the edge data to generate a point cloud of the measurement target W with the scanner imaging parts 64 and 65 of the three-dimensional scanner 2 as references. Since the positional relationship between the scanner imaging parts 64 and 65 of the three-dimensional scanner 2 and the self-luminous markers 71 to 77, 81 to 87, 91 to 97, and 101 to 107 is known in advance, a point cloud of the measurement target W with the reference camera 34 as a reference is generated based on the center position information of the self-luminous markers 71 to 77, 81 to 87, 91 to 97, and 101 to 107 obtained with the reference camera 34 as the reference and the point cloud of the measurement target W obtained with the scanner imaging parts 64 and 65 as the references.

In this example, as illustrated in FIG. 2, the imaging unit 3 includes a memory 39a that sequentially accumulates pieces of the edge data generated by the scanner image processing unit 147, and an association unit 39b that associates pieces of the edge data with pieces of the center position information of the scanner markers based on identification information. For example, in a case of sequentially measuring a plurality of the measurement targets W or in a case of sequentially measuring different portions of the same measurement target W, the scanner image processing unit 147 generates a plurality of pieces of the edge data. The plurality of pieces of generated edge data are transmitted from the third wireless communication unit 144 of the three-dimensional scanner 2 to the imaging unit 3 with mutually different pieces of identification information being tied thereto. The plurality of pieces of edge data transmitted from the third wireless communication unit 144 of the three-dimensional scanner 2 are accumulated in the memory 39a of the imaging unit 3 with pieces of the identification information being tied thereto.

When the three-dimensional data generation unit 43a is caused to generate the point cloud indicating the three-dimensional shape, the association unit 39b specifies center position information of a scanner marker to be transmitted to the three-dimensional data generation unit 43a. The association unit 39b specifies edge data having identification information tied to the specified center position information of the scanner marker from among the plurality of pieces of edge data accumulated in the memory 39a. Thereafter, the association unit 39b associates the specified edge data with the center position information of the scanner marker. The communication unit 37 of the imaging unit 3 transmits the edge data specified by the association unit 39b and the center position information of the scanner marker in association with each other to the three-dimensional data generation unit 43a. That is, a processing content is different between the generation of the center position information of the scanner marker and the generation of the edge data, and thus, there is a case where a timing at which the processing ends is different therebetween. However, the synchronization based on the trigger ID as in this example enables generation of the point cloud indicating the three-dimensional shape between corresponding ones regardless of a difference between the timings at which the processing ends.

At the time of measurement by the probe 5, the measurement worker brings the contact 121a into contact with a point (measurement point) of the measurement target W to be measured, and then operates the operation unit 124. Then, the trigger generation unit 38 generates a trigger to execute light emission of the probe marker 5B, imaging of the probe marker, light emission of the light emitting body 31b, and imaging of the light emitting body 31b by the reference camera 34 in synchronization. The camera image processing unit 35 generates the center position information of the probe marker. The processing unit 4 receives center position information of the probe marker generated by the camera image processing unit 35 via the second wireless communication unit 46. The three-dimensional data generation unit 43a generates three-dimensional coordinates of the measurement point pointed by the contact 121a based on the center position information of the probe marker generated by the camera image processing unit 35 and position and posture information of the scanner imaging camera 32. Although not illustrated, the probe marker is an image (different in practice) such as the image 102 on the upper side in FIG. 11, and the center position information of the probe marker can be expressed as Table 103 on the lower side in FIG. 11.

### Measurement by Three-Dimensional Measurement Device 1

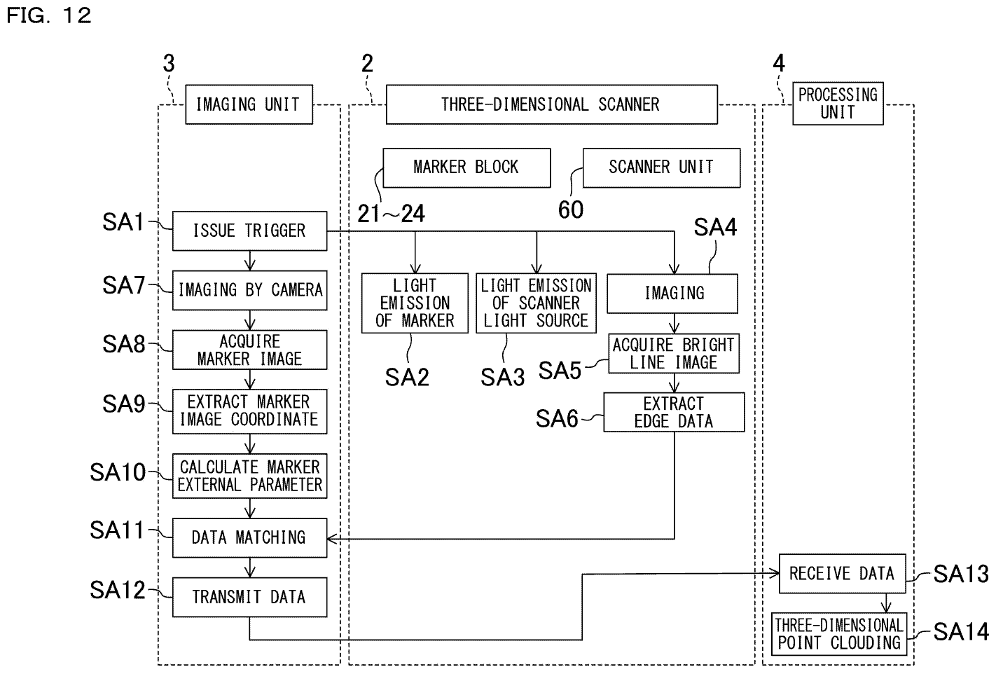

Next, a procedure of three-dimensional shape measurement of the measurement target W by the three-dimensional measurement device 1 configured as described above will be described with reference to a flowchart illustrated in FIG. 12. The measurement worker holds the grip part 112 of the three-dimensional scanner 2 and orients the scanner unit 60 toward the measurement target W, and then, operates the measurement start button included in the operation unit 114. Then, in Step SA1, the trigger generation unit 38 of the imaging unit 3 issues a trigger. An ID as identification information is assigned to the trigger. The trigger issued by the imaging unit 3 is received by the third wireless communication unit 144 of the three-dimensional scanner 2 via the first wireless communication unit 36 of the imaging unit 3. Then, in Step SA2, the scanner control part 142 of the three-dimensional scanner 2 outputs a light emission instruction to the marker lighting control part 141, and the marker lighting control part 141 causes the scanner markers 71 to 77, 81 to 87, 91 to 97, and 101 to 107 to emit light. In Step SA3, the scanner control part 142 of the three-dimensional scanner 2 outputs a light emission instruction to the scanner light source control part 146, and the scanner light source control part 146 causes the first scanner light source 62 or the second scanner light source 63 to emit light. Which of the first scanner light source 62 and the second scanner light source 63 is caused to emit light is determined in advance at the time of pre-setting.

Further, in Step SA4, at the same time as Step SA3, the scanner control part 142 of the three-dimensional scanner 2 outputs an imaging instruction to the scanner image processing unit 147, and the scanner image processing unit 147 causes the first scanner imaging part 64 and the second scanner imaging part 65 to execute imaging. In Step SA5, a bright line image is acquired by the imaging by the first scanner imaging part 64 and the second scanner imaging part 65. A trigger ID (identification information) is tied to a luminance image. In Step SA6, the bright line image is input to the scanner image processing unit 147, and the scanner image processing unit 147 extracts edge data with respect to the bright line image. The edge data is received by the first wireless communication unit 36 of the imaging unit 3 via the third wireless communication unit 144 of the three-dimensional scanner 2.

Meanwhile, in the imaging unit 3, after the trigger is issued in Step SA1, the processing proceeds to Step SA7, the body control part 33 outputs an imaging instruction to the camera image processing unit 35, and the camera image processing unit 35 causes the scanner imaging camera 32 to execute imaging. At this time, since each of the first to fourth marker blocks 21 to 24 includes the scanner markers 71 to 77, 81 to 87, 91 to 97, and 101 to 107 that emit light in a plurality of directions, even if an orientation and a posture of the three-dimensional scanner 2 change variously, the number of scanner markers necessary for measurement is arranged to face the scanner imaging camera 32 of the imaging unit 3. Therefore, in Step SA8, the scanner imaging camera 32 can acquire a scanner marker image including a plurality of scanner markers. A trigger ID is tied to the scanner marker image.

In Step SA9, the scanner marker image is input to the camera image processing unit 35 of the imaging unit 3, and the camera image processing unit 35 extracts a scanner marker image coordinate. In Step SA10, a marker external parameter is calculated. The marker external parameter is a six-axis parameter. In Step SA10, data matching between the edge data transmitted from the three-dimensional scanner 2 and the scanner marker image coordinate is executed based on the trigger ID. Details of the data matching will be described later.

In Step SA12, data obtained in Step SA11 is transmitted to the second wireless communication unit 46 of the processing unit 4 via the communication unit 37. In Step SA13, the control part 43 of the processing unit 4 processes the data transmitted from the imaging unit 3. In Step SA14, the three-dimensional data generation unit 43a generates a three-dimensional point cloud. As a result, a three-dimensional shape of the measurement target W is obtained.

### Details of Data Matching

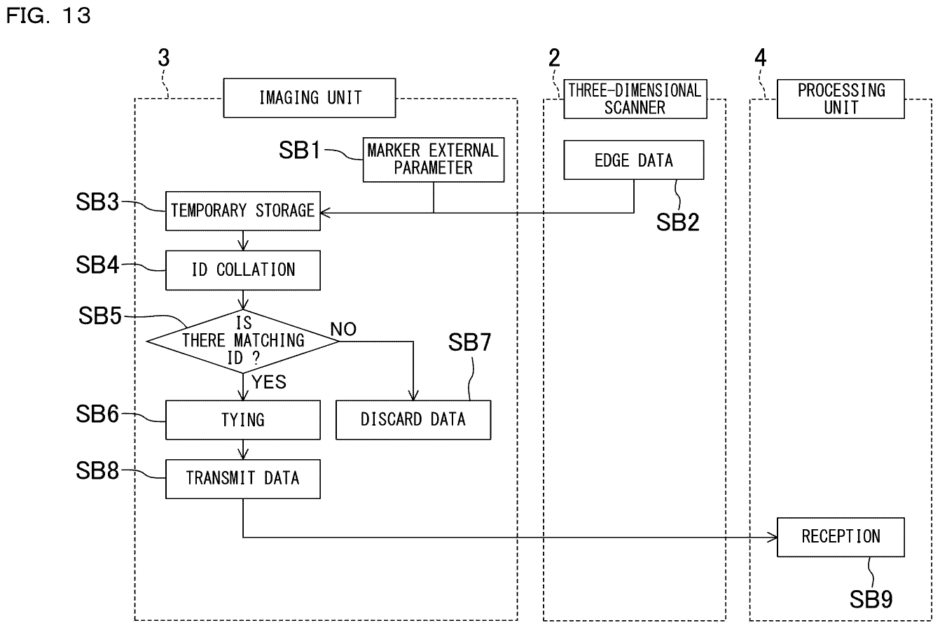

FIG. 13 is a flowchart illustrating an example of a procedure of data matching processing. In Step SB1, the imaging unit 3 acquires data of the marker external parameter calculated in Step SA10 of the flowchart illustrated in FIG. 12. Further, in Step SB2, the three-dimensional scanner 2 acquires the edge data extracted in Step SA6 of the flowchart illustrated in FIG. 12, and transmits the edge data to the imaging unit 3. In Step SB3, the imaging unit 3 temporarily stores the marker external parameter data acquired in Step SB1 and the edge data acquired in Step SB2.

In Step SB4, ID collation between the marker external parameter data and the edge data is executed based on the trigger IDs assigned in advance. In Step SB5, it is determined whether the trigger IDs match. If the trigger IDs match, the marker external parameter data is tied to the edge data in Step SB6. If the trigger IDs do not match, the marker external parameter data and the edge data are discarded in Step SB7. After Step SB6, data transmission processing with respect to the processing unit 4 is executed in Step SB8. In Step SB9, the processing unit 4 receives the data. (Construction of Wireless Network)

The three-dimensional measurement device 1 includes a plurality of terminals capable of wireless communication, and it is necessary to construct a wireless network between these terminals. Typically, the wireless network can be constructed by using a wireless LAN router connectable to the Internet as a master unit and using the first wireless communication unit 36 of the imaging unit 3, the second wireless communication unit 46 of the processing unit 4, the third wireless communication unit 144 of the three-dimensional scanner 2, and the fourth wireless communication unit 128 of the probe 5 as slave units. However, in this case, it is difficult to grasp, inside the three-dimensional measurement device 1, how many and which terminals are connected in one wireless network. Therefore, in the present embodiment, any one of the first wireless communication unit 36 of the imaging unit 3, the second wireless communication unit 46 of the processing unit 4, the third wireless communication unit 144 of the three-dimensional scanner 2, and the fourth wireless communication unit 128 of the probe 5 can be caused to function as the master unit. Here, a case where the first wireless communication unit 36 of the imaging unit 3 functions as the master unit will be described, but another wireless communication unit may function as the master unit. (Generation of Texture Image)

When the three-dimensional scanner 2 receives a trigger signal for texture acquisition by the communication control part 149, the scanner control part 142 can control the texture camera 66 to execute imaging. Note that the trigger signal may be distinguished between a trigger signal for three-dimensional shape measurement and the trigger signal for texture acquisition, and a part or all thereof may be shared. The trigger signal for three-dimensional shape measurement and the trigger signal for texture acquisition may be distinguished from each other, and by sharing a part or all of them, it is possible to enhance synchronization between the imaging by the scanner imaging parts 64 and 65 and the imaging by the texture camera 66. Further, the trigger signal for texture acquisition may be generated by the trigger generation unit 38 of the imaging unit 3 according to an operation signal received by the operation input unit 42 of the processing unit 4.

When the trigger signal for texture acquisition is generated, the reference camera 34 captures images of the light emitting bodies 31b. Then, the camera image processing unit 35 acquires pieces of the arrangement information of the light emitting bodies 31b stored in the storage unit 39c of the imaging unit 3, processes the images of the light emitting bodies 31b generated by the reference camera 34 based on pieces of the arrangement information of the light emitting bodies 31b, and generates the position and posture information of the scanner imaging camera 32 with respect to the reference camera 34.

The scanner imaging camera 32 generates a marker image including the self-luminous markers 71 to 77, 81 to 87, 91 to 97, and 101 to 107 of the three-dimensional scanner 2. Further, the reference camera 34 captures images of a plurality of the light emitting bodies 31b provided in the movable imaging part 3A and generates an image including the light emitting bodies 31b. Then, the camera image processing unit 35 of the imaging unit 3 calculates position and posture information of the three-dimensional scanner 2 with the scanner imaging camera 32 as a reference based on the marker image including the self-luminous markers 71 to 77, 81 to 87, 91 to 97, and 101 to 107 and pieces of the arrangement information of the self-luminous markers 71 to 77, 81 to 87, 91 to 97, and 101 to 107 acquired from the storage unit 143 of the three-dimensional scanner 2. Further, thus, the position and posture of the three-dimensional scanner 2 with the reference camera 34 as the reference are calculated.

Further, the texture camera 66 of the three-dimensional scanner 2 is controlled in synchronization with the generation of the trigger signal for texture acquisition, thereby generating a texture image. The texture image generated here is obtained with the texture camera 66 as a reference. Since the positional relationship between the texture camera 66 of the three-dimensional scanner 2 and the self-luminous markers 71 to 77, 81 to 87, 91 to 97, and 101 to 107 is known in advance, the texture image can be superimposed on a point cloud of the measurement target W with the reference camera 34 as a reference based on the position and posture (the center position information of each of the self-luminous markers 71 to 77, 81 to 87, 91 to 97, and 101 to 107) of the three-dimensional scanner 2 with the reference camera 34 obtained as the reference and the texture image of the measurement target W obtained with the texture camera 66 as the reference.

### Functions and Effects of Embodiment

As described above, at the time of measurement by the three-dimensional scanner 2, the scanner light sources 62 and 63 can emit pattern light so that the scanner imaging parts 64 and 65 can generate the bright line image including the pattern light. Further, the scanner markers 71 to 77, 81 to 87, 91 to 97, and 101 to 107 can emit light so that the movable imaging part 3A can generate a scan mama image. The center position information of the scanner marker generated by processing the scanner marker image generated by the movable imaging part 3A is transmitted to the processing unit 4 by the first wireless communication unit 36. At this time, since the amount of data is decreased as compared with a case where image data of the scanner marker image is directly transmitted, transmission at a high frame rate is possible while securing convenience by the wireless communication. The processing unit 4 can generate the point cloud indicating the three-dimensional shape of the measurement target W using the center position information of the scanner marker transmitted by the first wireless communication unit 36.

Further, for example, when the trigger signal as the identification information is generated by the trigger generation unit 38 based on the measurement instruction by the measurement worker, the scanner light source 62 or 63 emits the pattern light, and the scanner imaging parts 64 and 65 generate the bright line image including the pattern light. Further, the scanner markers 71 to 77, 81 to 87, 91 to 97, and 101 to 107 of the three-dimensional scanner 2 emit light, and the scanner imaging camera 32 of the imaging unit 3 generates the scanner marker image including the plurality of scanner markers 71 to 77, 81 to 87, 91 to 97, and 101 to 107. These are synchronously executed based on the trigger signal.

The edge data generated by processing the bright line image generated by the scanner imaging parts 64 and 65 is received by the three-dimensional data generation unit 43a to be tied to the identification information corresponding to the edge data. Further, the center position information of each of the scanner markers generated by processing the scanner marker image generated by the scanner imaging camera 32 is received by the three-dimensional data generation unit 43a to be tied to the identification information. As a result, the three-dimensional data generation unit 43a can generate the point cloud indicating the three-dimensional shape of the measurement target W based on the edge data and the center position information of each of the scanner markers without erroneously combining the edge data and the center position information of each of the scanner markers acquired at the same timing. That is, it is sufficient to transmit the edge data obtained by processing the bright line image and the center position information of each of the scanner markers obtained by processing the scanner marker image to the three-dimensional data generation unit 43a, and thus, a data amount is reduced as compared with a case where image data such as the bright line image and the scanner marker image is directly transmitted, and transmission at a high frame rate becomes possible, whereby high-speed scanning can be implemented by the three-dimensional scanner 2.

The above-described embodiment is merely an example in all respects, and should not be construed as limiting. Furthermore, all modifications and changes belonging to the equivalent range of the claims fall within the scope of the invention. For example, the trigger may be generated by the three-dimensional scanner 2 and transmitted to the imaging unit 3. Further, the trigger may be generated by the processing unit 4 and transmitted to the three-dimensional scanner 2 and the imaging unit 3.

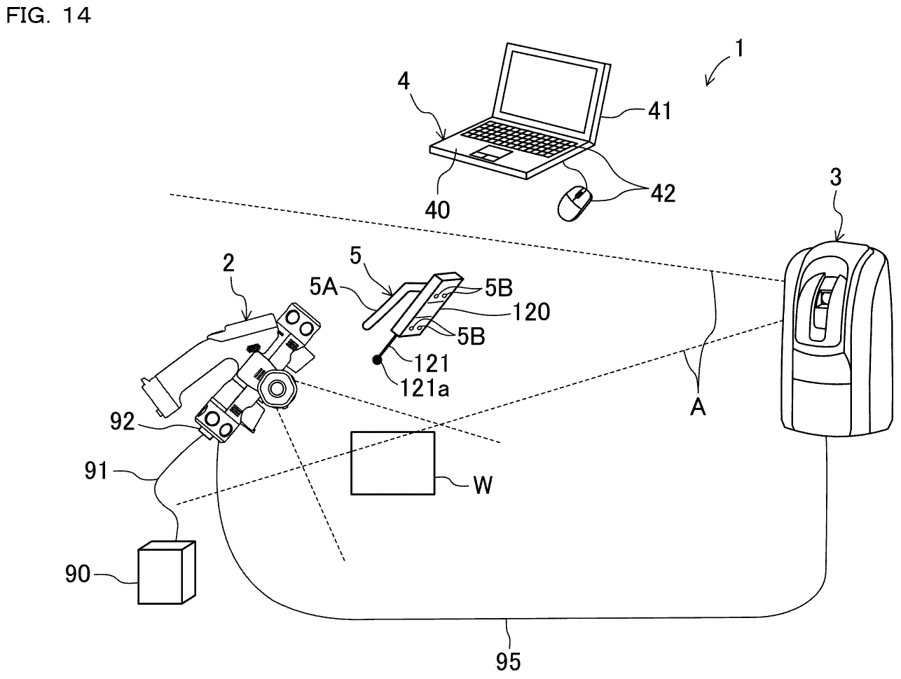

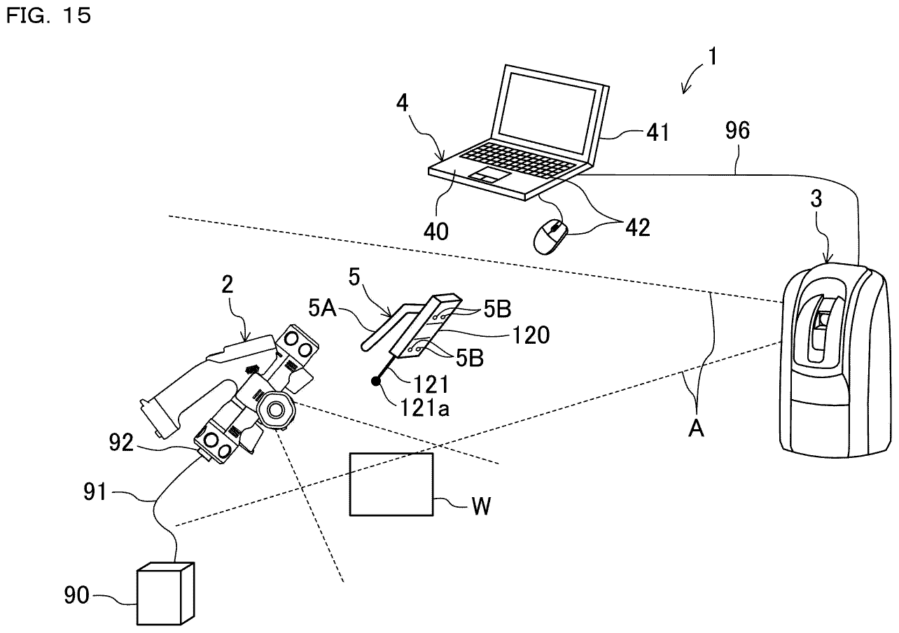

Although all of the three-dimensional scanner 2, the probe 5, the imaging unit 3, and the processing unit 4 are configured to be able to perform the wireless communication in the above-described example, but the invention is not limited thereto, and in some cases, some equipment may be connected in wired manner as in a first modification illustrated in FIG. 14 or a second modification illustrated in FIG. 15.

In the first modification illustrated in FIG. 14, the three-dimensional scanner 2 and the imaging unit 3 are connected by a signal line 95 to be capable of communicating with each other. In this example, a trigger generated by the imaging unit 3 can be transmitted to the three-dimensional scanner 2 via the signal line 95, and an image or information generated by the three-dimensional scanner 2 can be transmitted to the imaging unit 3 via the signal line 95.

In the second modification illustrated in FIG. 15, the imaging unit 3 and the processing unit 4 are connected by the signal line 95 to be capable of communicating with each other. In this example, various images and information can be transmitted from the imaging unit 3 to the processing unit 4 via the signal line 95.

### Configuration Example of Light Source

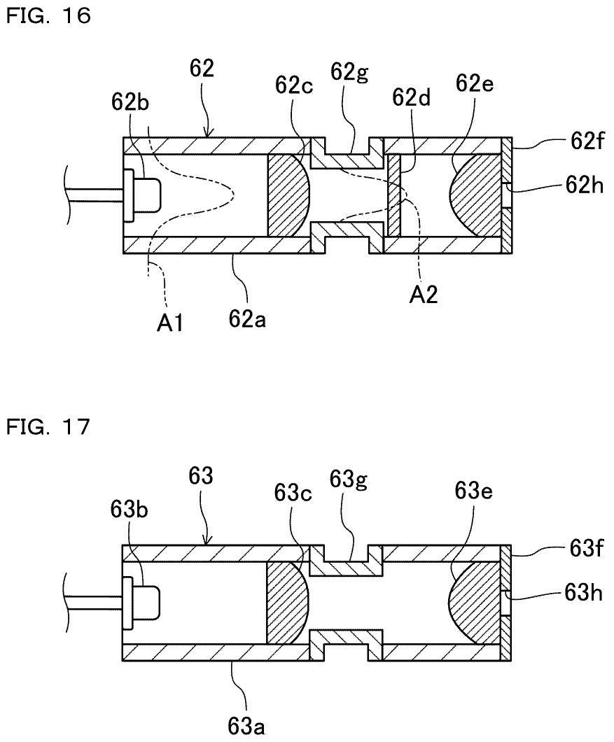

The first scanner light source 62 is a first light source module, and is not particularly limited, but can have a configuration as illustrated in FIG. 16, for example. That is, the first scanner light source 62 includes a first lens barrel 62a that has a cylindrical shape and is attached to the scanner body 20, a first laser light source 62b, a first collimator lens 62c, a first diffractive optical element 62d, a first Powell lens 62e, and a first slit forming member 62f. The first laser light source 62b is arranged at a proximal end of the first lens barrel 62a. An optical axis of the first laser light source 62b coincides with an axis of the first lens barrel 62a, and extends toward a distal end of the first lens barrel 62a. Two or more first laser light sources 62b may be provided.

The first collimator lens 62c is provided at an intermediate portion in the axial direction in the first lens barrel 62a. Laser light emitted from the first laser light source 62b is incident on the first collimator lens 62c. The first collimator lens 62c is a first condenser lens that condenses the laser light emitted from the first laser light source 62b. The first diffractive optical element (first optical element) 62d is provided in a portion distant from the first collimator lens 62c toward the distal end side of the first lens barrel 62a in the first lens barrel 62a. The laser light emitted from the first collimator lens 62c is incident on the first diffractive optical element 62d. The first diffractive optical element 62d is an element configured to branch the laser light condensed by the first collimator lens 62c into a plurality of light beams. The first Powell lens 62e is provided in a part distant from the first diffractive optical element 62d toward the distal end side of the first lens barrel 62a in the first lens barrel 62a, and is positioned at the distal end of the first lens barrel 62a in the present embodiment. The first Powell lens 62e is a member configured to one-dimensionally expand each of the plurality of light beams branched by the first diffractive optical element 62d to generate multi-line light, and is also referred to as a degauss lens. A cylindrical lens may be used instead of the first Powell lens 62e.

The second scanner light source 63 is a second light source module, and is not particularly limited, but can have a configuration as illustrated in FIG. 17, for example. That is, a basic structure of the second scanner light source 63 is similar to that of the first scanner light source 62, but is different in that a diffractive optical element is not provided since the second scanner light source forms single-line light.

Specifically, the second scanner light source 63 includes a second lens barrel 63a that has a cylindrical shape and is attached to the scanner body 20, a second laser light source 63b, a second collimator lens 63c, a second Powell lens 63e, and a second slit forming member 63f. The second laser light source 63b is arranged at a proximal end of the second lens barrel 63a. An optical axis of the second laser light source 63b coincides with an axis of the second lens barrel 63a, and extends toward a distal end of the second lens barrel 63a. The second laser light source 63b and the first laser light source 62b may be the same light source or different light sources.

The second collimator lens 63c is provided at an intermediate portion in the axial direction in the second lens barrel 63a. Laser light emitted from the second laser light source 63b is incident on the second collimator lens 63c. The second collimator lens 63c is a second condenser lens that condenses the laser light emitted from the second laser light source 63b. The second Powell lens 63e is provided in a part distant from the second collimator lens 63c toward the distal end side of the second lens barrel 63a in the second lens barrel 63a, and is positioned at the distal end of the second lens barrel 63a in the present embodiment. The second Powell lens 63e is a member configured to one-dimensionally expand the laser light condensed by the second collimator lens 63c to generate single-line light that is light stronger than each line light of the multi-line light, and is also referred to as a degauss lens. A cylindrical lens may be used instead of the second Powell lens 63e.

As described above, in the first scanner light source 62, the light emitted from one laser light source 62b is branched into a plurality of beams of the multi-line light by the first diffractive optical element 62d, and thus the intensity of light per line decreases in inverse proportion to the number of branches. However, in the second scanner light source 63, the light emitted from the laser light source 63b is not branched into a plurality of beams of light, and thus the single-line light brighter than each line light of the multi-line light is generated accordingly.

imaginary line Al illustrated in FIG. 16 schematically illustrates an intensity distribution of the laser light emitted from the first laser light source 62b. As indicated by the imaginary line A1, the intensity distribution of the laser light emitted from the first laser light source 62b becomes a distribution that can be approximately regarded as a Gaussian distribution, so that the laser light emitted from the first laser light source 62b can be called a Gaussian beam. The laser light emitted from the second laser light source 63b is similarly a Gaussian beam.

Here, the three-dimensional scanner 2 is used while being held and moved by the measurement worker's hand, there is a demand for miniaturization as much as possible. In order to satisfy this requirement, it is conceivable to downsize the first scanner light source 62. In downsizing the first scanner light source 62, it is possible to adopt a structure in which a small-diameter part is provided in the intermediate portion in the axial direction of the first lens barrel 62a. That is, a first small-diameter lens barrel 62g having a radial length smaller than a power distribution width of the laser light can be provided between the first laser light source 62b and the first Powell lens 62e. The length of the first small-diameter lens barrel 62g can be set in any manner.

When the first small-diameter lens barrel 62g is provided, a peripheral portion of the laser light emitted from the first laser light source 62b is vignetted by the first small-diameter lens barrel 62g, and the intensity distribution of the laser light in the first small-diameter lens barrel 62g becomes an intensity distribution as indicated by imaginary line A2.

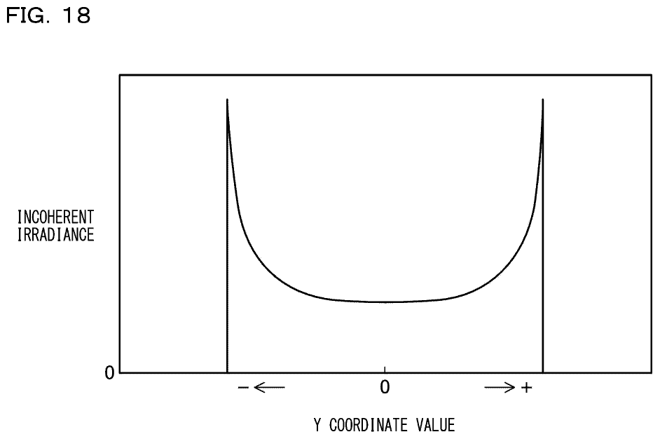

On the other hand, as illustrated in FIG. 18, the first Powell lens 62e has an optical characteristic capable of outputting line laser light having a uniform intensity distribution in a direction orthogonal to the optical axis on the premise that a Gaussian beam is incident. Therefore, when the laser light whose peripheral portion is vignetted by the first small-diameter lens barrel 62g, that is, the laser light that is not a Gaussian beam is incident on the first Powell lens 62e, laser light whose peripheral portion is increased in intensity is emitted from the first lens barrel 62a.

Equipment that emits laser light such as the three-dimensional scanner 2 of the present embodiment is desired to reduce the intensity of light in a peripheral portion that is hardly used at the time of three-dimensional measurement in consideration of safety. In the present embodiment, this problem is solved by providing the first slit forming member 62f as illustrated in FIG. 16. The first slit forming member 62f is configured to form a first slit 62h that blocks light at an end of multi-line light generated by the first Powell lens 62e, and can be provided at a position where the light emitted from the first Powell lens 62e is incident. In the present embodiment, the first slit forming member 62f is provided at the distal end of the first lens barrel 62a, and the first slit 62h is formed at the central portion thereof. The first slit 62h has a smaller diameter than an inner diameter of the first small-diameter lens barrel 62g. The center of the first slit 62h is located on the optical axis of the first laser light source 62b.

When the light emitted from the first Powell lens 62e passes through the first slit 62h, the end of the light is blocked by the first slit forming member 62f, so that the light at the end with high intensity can be prevented from being emitted. As a result, it is possible to sufficiently secure the intensity of light in the central portion which is important at the time of three-dimensional measurement.

Similarly to the first scanner light source 6, the second scanner light source 63 illustrated in FIG. 17 is provided with a second small-diameter lens barrel 63g, so that a beam shape changes from a Gaussian beam. Therefore, the second scanner light source 63 is also provided with the second slit forming member 63f having a second slit 63h in order to reduce the intensity of light in a peripheral portion.

### Example of Measurement Control

When multi-line light having passed through the first slit 62h is emitted from the first scanner light source 62 including the first slit forming member 62f, the first scanner imaging part 64 and the second scanner imaging part 65 capture images of the multi-line light emitted from the first scanner light source 62 and generate a bright line image including the multi-line light. Further, when single-line light having passed through the second slit 63h is emitted from the second scanner light source 63 including the second slit forming member 63f, the first scanner imaging part 64 and the second scanner imaging part 65 capture images of the single-line light emitted from the second scanner light source 63 and generate a bright line image including the single-line light. When the first scanner imaging part 64 and the second scanner imaging part 65 generate the bright line images, the processing unit 4 generates a point cloud indicating a three-dimensional shape of the measurement target W based on each of the bright line images.

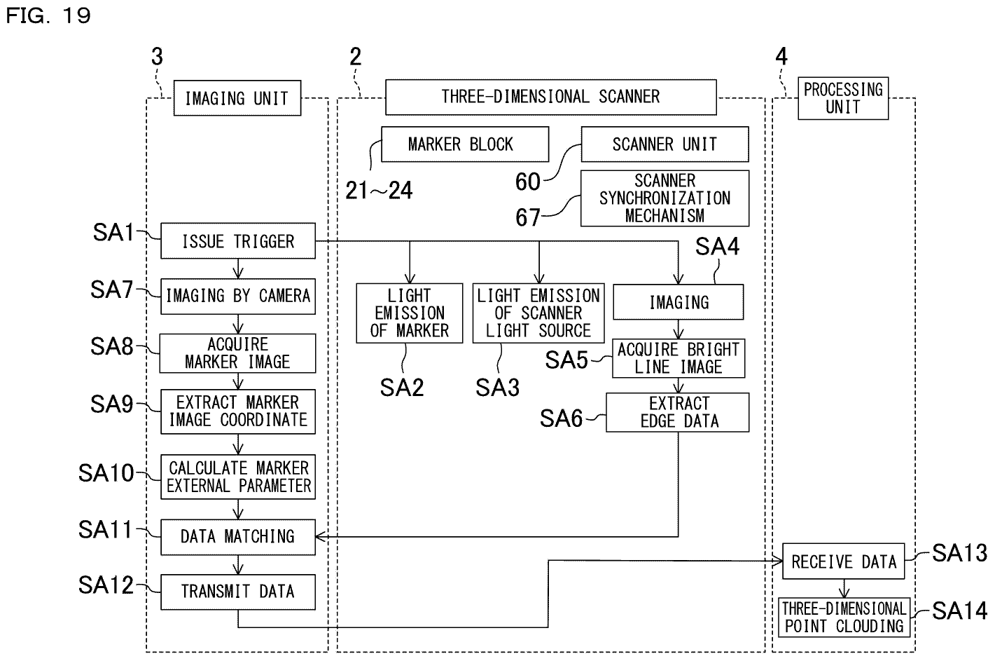

As illustrated in FIG. 19, the three-dimensional scanner 2 includes a scanner synchronization mechanism 67 that generates scanner identification information corresponding to a trigger generated by the trigger generation unit 38 in response to reception of the trigger. The body control part 33 and the scanner control part 142 synchronize emission of pattern light from the first scanner light source 62 and the second scanner light source 63, imaging by the first scanner imaging part 64 and the second scanner imaging part 65, and light emission of the markers.

That is, the camera image processing unit 35 processes a scanner marker image generated by the movable imaging part 3A, and generates second measurement information associated with synchronization identification information generated by the trigger generation unit 38.

The optical communication interface 36a of the first wireless communication unit 36 of the imaging unit 3 transmits the trigger generated by the trigger generation unit 38 to the three-dimensional scanner 2. The three-dimensional scanner 2 receives the trigger transmitted from the optical communication interface 36a of the first wireless communication unit 36 via the optical communication interface 144a of the third wireless communication unit 144.

When the trigger is received via the optical communication interface 144a of the third wireless communication unit 144, the body control part 33 and the scanner control part 142 execute the following control. That is, in response to the reception of the trigger via the optical communication interface 144a of the third wireless communication unit 144, the body control part 33 and the scanner control part 142 synchronize the generation of the scanner identification information by the scanner synchronization mechanism 67, the emission of the pattern light from the first scanner light source 62 and the second scanner light source 63, the imaging by the first scanner imaging part 64 and the second scanner imaging part 65, and the light emission of the markers.

When the scanner synchronization mechanism 67 generates first measurement information, the three-dimensional scanner 2 executes processing of associating the first measurement information generated by the scanner image processing unit 147 with the scanner identification information corresponding to the first measurement information generated by the scanner synchronization mechanism 67. After executing the processing of associating the first measurement information with the scanner identification information, the three-dimensional scanner 2 transmits the first measurement information to the imaging unit 3 via the optical communication interface 144a of the third wireless communication unit 144.

The imaging unit 3 receives the first measurement information transmitted from the three-dimensional scanner 2. Then, the imaging unit 3 executes processing of associating the second measurement information generated by the camera image processing unit 35 and the first measurement information generated by the scanner image processing unit 147 based on the synchronization identification information associated with the second measurement information and the scanner identification information associated with the first measurement information. The imaging unit 3 is configured to transmit the second measurement information and the first measurement information to the second wireless communication unit 46 via the radio communication interface 36b of the first wireless communication unit 36 after executing such association processing.

Further, in response to the generation of the trigger by the trigger generation unit 38, the movable imaging part 3A captures images of the markers of the three-dimensional scanner 2 repeatedly the predetermined number of times, and sequentially generates the second images including the markers. In this case, the camera image processing unit 35 processes each of the second images generated by the movable imaging part 3A, and sequentially generates the second measurement information associated with the synchronization identification information sequentially generated by the trigger generation unit 38.

When receiving the trigger generated by the trigger generation unit 38, the body control part 33 and the scanner control part 142 repeatedly execute the generation of the scanner identification information by the scanner synchronization mechanism 67, the emission of the pattern light from the first scanner light source 62 and the second scanner light source 63, the imaging by the first scanner imaging part 64 and the second scanner imaging part 65, and the light emission of the markers the predetermined number of times in response to reception of the trigger signal. In short, it is possible to execute burst imaging in which imaging is performed a plurality of times by one trigger input. This burst imaging can be applied to both the three-dimensional scanner 2 and the contact probe 5, but may be applied to only one of them.

The body control part 33 and the scanner control part 142 can receive a switching input for switching between the emission of the multi-line light and the emission of the single-line light. This switching input may be an input from the user or an input by a control signal automatically generated when a predetermined condition is satisfied. In response to the reception of the switching input, the scanner control part 142 controls the first scanner light source 62 to emit the multi-line light from the first scanner light source 62. In a case where the multi-line light is emitted, an emission timing of the multi-line light by the first scanner light source 62, the imaging by the first scanner imaging part 64 and the second scanner imaging part 65, and the light emission of the markers can be synchronized.

Further, in response to the reception of the switching input, the scanner control part 142 controls the second scanner light source 63 to emit the single-line light from the second scanner light source 63. At this time, the scanner control part 142 stops the emission of the multi-line light from the first scanner light source 62, and then executes the emission processing of the single-line light from the second scanner light source 63. In a case where the single-line light is emitted, an emission timing of the multi-line light of the second scanner light source 63, the imaging by the first scanner imaging part 64 and the second scanner imaging part 65, and the light emission of the marker can be synchronized.

The processing unit 4 acquires data of the point cloud indicating the three-dimensional shape of the measurement target W generated based on the bright line image including the multi-line light and data of the point cloud indicating the three-dimensional shape of the measurement target W generated based on the bright line image including the single-line light. Then, the processing unit 4 combines the point cloud indicating the three-dimensional shape of the measurement target W generated based on the bright line image including the multi-line light and the point cloud indicating the three-dimensional shape of the measurement target W generated based on the bright line image including the single-line light to generate a point cloud indicating a three-dimensional shape of the measurement target W.

There is a case where the measurement target W includes a specular reflection region and a non-specular reflection region, but even such a measurement target W can be three-dimensionally measured by the three-dimensional measurement device 1 according to the present embodiment. As one of configurations that make this possible, a configuration in which the intensity of the single-line light emitted from the second scanner light source 63 is increased as described above can be exemplified. As a result, even for a mirror surface on which the intensity of light per line is low and it is difficult to acquire point cloud data as in the first scanner light source 62, point cloud data can be acquired by using strong line light emitted from the second scanner light source 63.

The specular reflection region is a region having a light reflectivity of a predetermined value or more, and for example, a metal surface or the like may correspond to the specular reflection region. That is, when the measurement target W includes the specular reflection region and the non-specular reflection region, the processing unit 4 generates a point cloud indicating a three-dimensional shape of the non-specular reflection region of the measurement target W based on the bright line image including the multi-line light, and generates a point cloud indicating a three-dimensional shape of the specular reflection region of the measurement target W based on the bright line image including the single-line light. Thereafter, the processing unit 4 combines the point cloud indicating the three-dimensional shape of the non-specular reflection region of the measurement target W and the point cloud indicating the three-dimensional shape of the specular reflection region of the measurement target W to generate a point cloud indicating a three-dimensional shape of the measurement target W including the specular reflection region and the non-specular reflection region.

The scanner imaging part includes the first scanner imaging part 64 as a first camera and the second scanner imaging part 65 as a second camera.

The scanner image processing unit 147 generates a plurality of pieces of first information from the bright line image including the multi-line light, and generates a plurality of pieces of first information from the bright line image including the single-line light. The processing unit 4 generates the point cloud indicating the three-dimensional shape of the measurement target W based on a plurality of pieces of first measurement information generated from the bright line image including the multi-line light or the bright line image including the single-line light and a positional relationship between the first scanner imaging part 64 and the second scanner imaging part 65.

Here, for example, when multiple reflection occurs in the specular reflection region of the measurement target W, a plurality of peaks are included in the bright line image even if the bright line image is obtained by capturing the single-line light, so that the plurality of pieces of first measurement information are acquired. In this case, since a peak at which the amount of reflected light is the maximum is not always true measurement information, in order to cope with such a case, the processing unit 4 specifies the true measurement information among the plurality of pieces of first measurement information generated from the bright line image including the single-line light based on the positional relationship between the first scanner imaging part 64 and the second scanner imaging part 65. Specifically, the processing unit 4 temporarily acquires a plurality of pieces of first measurement information, and specifies the first information matching a measurement position of the measurement target W among the plurality of pieces of first measurement information as the true measurement information. The processing unit 4 can generate the point cloud indicating the three-dimensional shape of the measurement target W based on the specified true measurement information and the positional relationship between the first scanner imaging part 64 and the second scanner imaging part 65.

The respective self-luminous markers included in the first to fourth marker blocks 21 to 24 may emit not only visible light but also invisible light. In a case where the self-luminous markers emit invisible light, the movable imaging part 3A captures images of the self-luminous markers that emit the invisible light and generates a second image including the self-luminous markers. The camera image processing unit 35 can process the second image including the self-luminous markers that emit the invisible light to generate second measurement information.

The processing unit 4 determines whether any one of the marker blocks 21 to 24 can be detected from the movable imaging part 3A. For example, in a case where a self-luminous marker is included in the second image, the processing unit 4 specifies which marker of the first to fourth marker blocks 21 to 24 the self-luminous marker is, thereby determining which marker block of the first to fourth marker blocks 21 to 24 can be detected. When there is no self-luminous marker included in the second image, the processing unit 4 determines that all the marker blocks 21 to 24 cannot be detected.

In a case where it is determined that any one of the marker blocks 21 to 24 can be detected, the processing unit 4 causes the self-luminous markers included in the marker block that can be detected from the movable imaging part 3A to emit light in a first color having a visible light wavelength. On the other hand, in a case where it is determined that any one of the marker blocks 21 to 24 cannot be detected, the processing unit 4 causes the self-luminous markers included in any one of the marker blocks 21 to 24 that cannot be detected from the movable imaging part 3 A to emit light in a second color different from the first color with a visible light wavelength. For example, the first color can be green, blue, or the like, and the second color can be red, yellow, or the like, but the invention is not limited thereto, and a display form may be different between the case where the detection is possible and the case where the detection is impossible. Further, the first color and the second color are preferably different from a color of light emission of the markers.

Further, the processing unit 4 can determine whether a position and a posture of the three-dimensional scanner 2 can be specified from the movable imaging part 3A based on the second image generated by the movable imaging part 3A, can cause the self-luminous markers included in the marker blocks 21 to 24 to emit light in the first color of the visible light wavelength in a case where it is determined that the position and posture of the three-dimensional scanner 2 can be specified, and can cause the self-luminous markers included in the marker blocks 21 to 24 to emit light in the second color different from the first color with a visible light wavelength in a case where it is determined that the position and posture of the three-dimensional scanner 2 cannot be specified.

When it is determined that the position and posture of the three-dimensional scanner 2 can be specified, the processing unit 4 can cause any one of the marker blocks 21 to 24 that can be detected from the movable imaging part 3A and any one of the marker blocks 21 to 24 that cannot be detected from the movable imaging part 3A to emit light in a distinguishable manner.

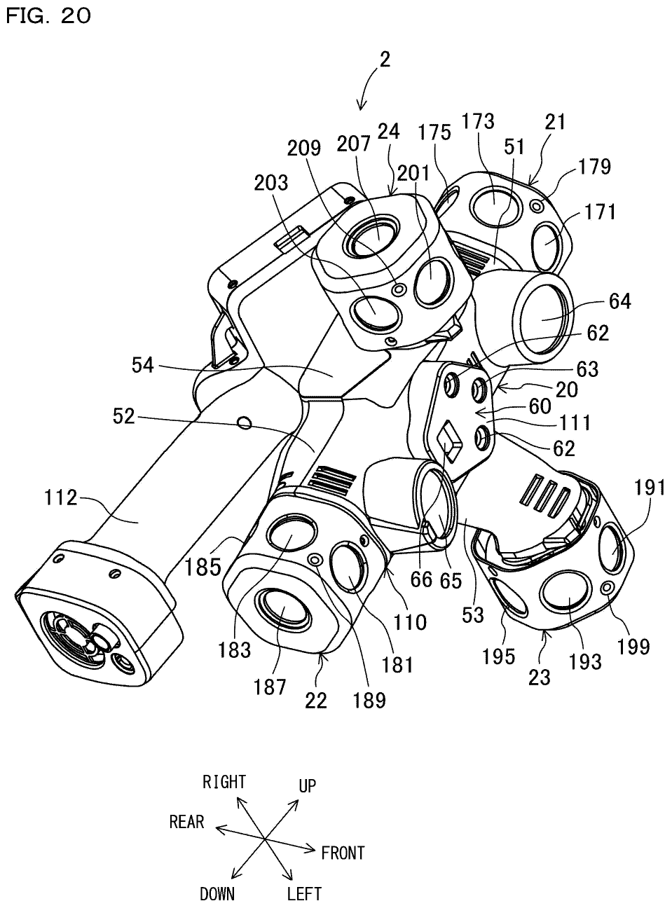

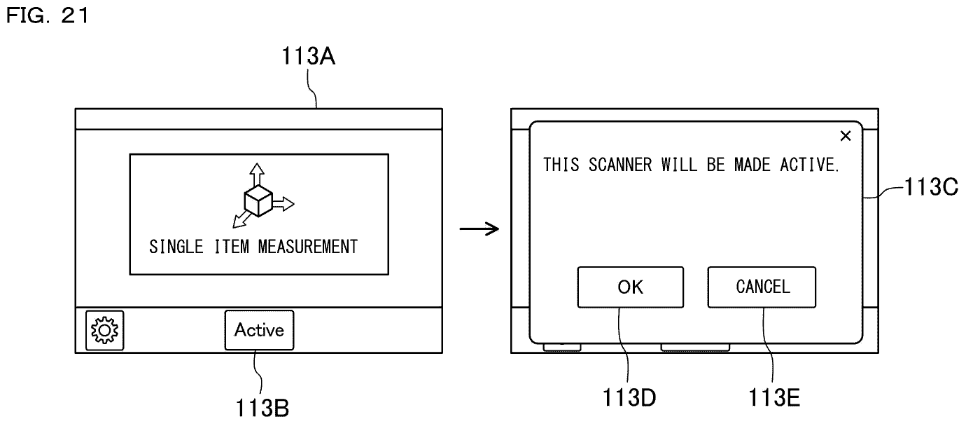

As described above, it is possible to notify that the position and posture of the three-dimensional scanner 2 can be specified by causing the marker blocks 21 to 24 to directly emit light. However, an indicator (for example, indicator lamps 179, 189, 199, and 209 illustrated in FIG. 20) different from the marker blocks 21 to 24 may be provided, and control may be executed such that the indicator is turned on when the position and posture of the three-dimensional scanner 2 can be specified, and the indicator is turned off when the position and posture of the three-dimensional scanner 2 cannot be specified. The indicator can be arranged for each of the self-luminous markers in the vicinity of the self-luminous marker. Further, the indicator can also be arranged for each of the marker blocks 21 to 24.

### Light Emission Control of Self-Luminous Marker

Lighting and non-lighting of the self-luminous markers included in the first to fourth marker blocks 21 to 24 can also be changed depending on whether the operation state of the three-dimensional scanner 2 is an active state or an inactive state. When the three-dimensional scanner 2 is in the active state, three-dimensional measurement is possible. On the other hand, when the three-dimensional scanner 2 is in the inactive state, three-dimensional measurement is impossible.

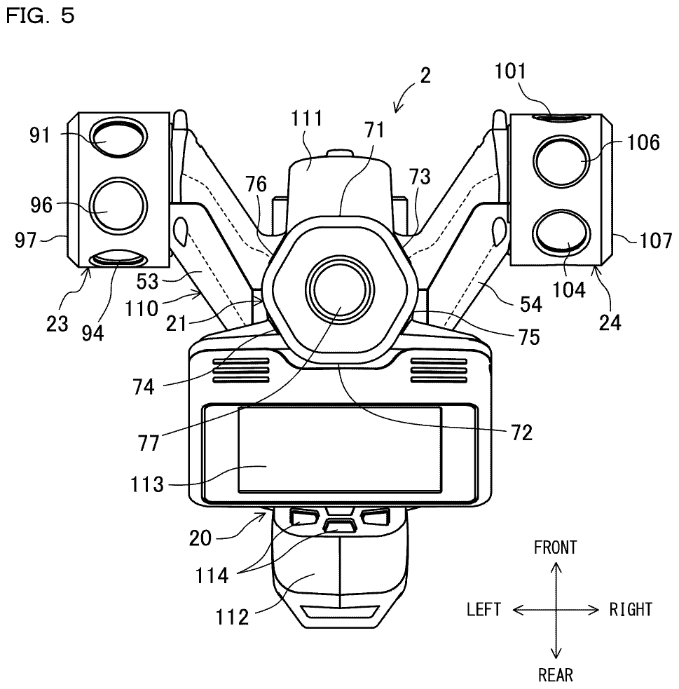

As illustrated in FIG. 21, when the three-dimensional scanner 2 is in the inactive state, a home screen 113A generated by the display control part 140 (illustrated in FIG. 8) is displayed on the display unit 113 (illustrated in FIG. 5) of the three-dimensional scanner 2. When the three-dimensional scanner 2 is in the inactive state, the marker lighting control part 141 turns off the self-luminous markers. As a result, the user can grasp that the three-dimensional scanner 2 is in the inactive state and three-dimensional measurement cannot be performed.

On the other hand, when the user switches the three-dimensional scanner 2 in the inactive state to the active state, the user presses a switch button 113B provided on the home screen 113A. The operation of the switch button 113B is detected by the touch panel 113a illustrated in FIG. 8. When detecting that the switch button 113B has been operated, the display control part 140 generates a message window 113C and displays the message window 113C on the display unit 113. In the message window 113C, an operation confirmation message such as “This scanner will be made active”, an OK button 113D, and a cancel button 113E are displayed. When the touch panel 113a detects that the OK button 113D has been operated, the three-dimensional scanner 2 is switched from the inactive state to the active state. That is, when an operation input for setting the operation state of the three-dimensional scanner 2 to the active state is detected, the operation state of the three-dimensional scanner 2 is switched to the active state, and the marker lighting control part 141 lights the self-luminous markers. The color of the self-luminous markers at this time varies depending on whether any one of the marker blocks 21 to 24 can be detected as described above. On the other hand, when the touch panel 113a detects that the cancel button 113E has been operated, the three-dimensional scanner 2 remains in the inactive state.

### Example of Retroreflective Marker

As illustrated in FIG. 20, the first to fourth marker blocks 21 to 24 may be provided with retroreflective markers 171, 173, 175, 181, 183, 185, 187, 191, 193, 195, 201, 203, and 207 made of a retroreflective material. In FIG. 20, only a part of the retroreflective markers can be illustrated for each of the first to fourth marker blocks 21 to 24 due to the perspective view, but the retroreflective markers are provided in each of the marker blocks 21 to 24 similarly to the self-luminous markers of the above embodiment. Further, in this example, the first to fourth indicator lamps 179, 189, 199, and 209 are provided in the first to fourth marker blocks 21 to 24, respectively.

The movable imaging part 3A moves a field of view such that the three-dimensional scanner 2 is within the field of view, and generates a second image including the retroreflective markers 171, 173, 175, 181, 183, 185, 187, 191, 193, 195, 201, 203, and 207 in order to measure a position and a posture of the three-dimensional scanner 2. The camera image processing unit 35 processes the second image generated by the movable imaging part 3A to generate second measurement information. The body control part 33 and the scanner control part 142 synchronize emission of pattern light from the first scanner light source 62 or the second scanner light source 63, imaging by the first scanner imaging part 64 and the second scanner imaging part 65, and imaging by the movable imaging part 3A in response to generation of identification information by the trigger generation unit 38. The processing unit 4 generates a point cloud indicating a three-dimensional shape of the measurement target W based on first measurement information generated by the scanner image processing unit 147 and the second measurement information generated by the camera image processing unit 35.

The processing unit 4 determines whether any one of the first to fourth marker blocks 21 to 24 can be detected from the movable imaging part 3A, and can cause the first to fourth indicator lamps 179, 189, 199, and 209 of the first to fourth marker blocks 21 to 24 to emit light in a color different from that of light reflected by the retroreflective markers according to the determination result. For example, when the fourth marker block 24 cannot be detected, only the fourth indicator lamp 209 is caused to emit light, and the first to third indicator lamps 179, 189, and 199 are turned off. That is, display control of the first to fourth indicator lamps 179, 189, 199, and 209 is executed such that the user can easily grasp whether the first to fourth marker blocks 21 to 24 can be detected from the movable imaging part 3A.

The processing unit 4 can determine whether the position and posture of the three-dimensional scanner 2 can be specified from the movable imaging part 3A based on the second image generated by the movable imaging part 3A, and can cause at least one of the first to fourth indicator lamps 179, 189, 199, and 209 to emit light when it is determined that the position and posture of the three-dimensional scanner 2 cannot be specified.

### INDUSTRIAL APPLICABILITY

As described above, the present invention can be used in the case of measuring three-dimensional shapes of various measurement targets.

### REFERENCE SIGNS LIST

1: THREE-DIMENSIONAL MEASUREMENT DEVICE
2: THREE-DIMENSIONAL SCANNER
3: IMAGING UNIT
4: PROCESSING UNIT (THREE-DIMENSIONAL DATA GENERATION UNIT)
3A: MOVABLE IMAGING PART
35: CAMERA IMAGE PROCESSING UNIT
36: FIRST WIRELESS COMMUNICATION UNIT
36A: OPTICAL COMMUNICATION INTERFACE
36B: RADIO COMMUNICATION INTERFACE
38: TRIGGER GENERATION UNIT (SYNCHRONIZATION MECHANISM)
46: SECOND WIRELESS COMMUNICATION UNIT
62, 63: SCANNER LIGHT SOURCE
64, 65: SCANNER IMAGING PART
71 TO 77: FIRST TO SEVENTH SCANNER MARKERS
128: FOURTH WIRELESS COMMUNICATION UNIT
142: SCANNER CONTROL PART (MEASUREMENT CONTROL PART)
144: THIRD WIRELESS COMMUNICATION UNIT
147: SCANNER IMAGE PROCESSING UNIT

1. A three-dimensional measurement device that measures a three-dimensional shape of a measurement target, the three-dimensional measurement device comprising:
a three-dimensional scanner including a scanner light source that emits pattern light, a scanner imaging part that captures an image of the pattern light emitted by the scanner light source to generate a first image including the pattern light, a scanner image processing unit that processes the first image generated by the scanner imaging part to generate first measurement information, and a plurality of markers;
an imaging unit including a movable imaging part that moves a field of view to make the three-dimensional scanner be within the field of view, and captures images of the markers for measuring a position and a posture of the three-dimensional scanner to generate a second image including the markers, a camera image processing unit that processes the second image generated by the movable imaging part to generate second measurement information, and a first wireless communication unit that transmits the second measurement information generated by the camera image processing unit; and
a three-dimensional data generation unit that includes a second wireless communication unit configured to receive the second measurement information transmitted via the first wireless communication unit, and generates a point cloud indicating the three-dimensional shape of the measurement target based on the first measurement information generated by the scanner image processing unit and the second measurement information received via the second wireless communication unit.

2. The three-dimensional measurement device according to claim 1, wherein the three-dimensional scanner includes a third wireless communication unit configured to transmit the first measurement information generated by the scanner image processing unit to the first wireless communication unit.

3. The three-dimensional measurement device according to claim 2, wherein the first wireless communication unit transmits the first measurement information received via the third wireless communication unit to the second wireless communication unit together with the second measurement information corresponding to the first measurement information.

4. The three-dimensional measurement device according to claim 1, further comprising a battery unit that is portable and configured to supply power to the three-dimensional scanner, wherein the three-dimensional scanner further includes a power supply port that receives power supply from the battery unit.

5. The three-dimensional measurement device according to claim 2, wherein each of the first wireless communication unit and the third wireless communication unit includes an optical communication interface and a radio communication interface.

6. The three-dimensional measurement device according to claim 5, wherein
the markers are self-luminous markers,
the imaging unit further includes a synchronization mechanism that generates identification information for identifying a synchronous execution timing based on a measurement instruction,
the three-dimensional scanner further includes a measurement control part that synchronizes emission of the pattern light from the scanner light source, imaging by the scanner imaging part, and light emission of the markers,
the optical communication interface of the first wireless communication unit transmits a synchronization signal generated by the synchronization mechanism to the three-dimensional scanner,
the three-dimensional scanner receives the synchronization signal via the optical communication interface of the third wireless communication unit, and
the measurement control part synchronizes the emission of the pattern light from the scanner light source, the imaging by the scanner imaging part, and the light emission of the markers in response to the reception of the synchronization signal via the optical communication interface of the third wireless communication unit.

7. The three-dimensional measurement device according to claim 5, wherein
the three-dimensional scanner transmits the first measurement information generated by the scanner image processing unit to the imaging unit via the radio communication interface of the third wireless communication unit, and
the imaging unit receives the first measurement information via the radio communication interface of the first wireless communication unit, and transmits the received first measurement information and the second measurement information generated by the camera image processing unit to the second wireless communication unit.

8. The three-dimensional measurement device according to claim 6, further comprising a contact-type probe that includes a plurality of the markers and a fourth wireless communication unit configured to receive the synchronization signal, and indicates a position of a measurement point,
wherein the movable imaging part generates a third image including the plurality of markers provided in the contact-type probe,
the camera image processing unit processes the third image generated by the movable imaging part to generate third measurement information, and
the first wireless communication unit transmits the third measurement information generated by the camera image processing unit.

9. The three-dimensional measurement device according to claim 8, wherein the fourth wireless communication unit includes an optical communication interface and a radio communication interface to receive the synchronization signal.

10. The three-dimensional measurement device according to claim 5, wherein
the imaging unit further includes a synchronization mechanism that generates a trigger for defining a synchronous execution timing and synchronization identification information for identifying the synchronous execution timing based on a measurement instruction,
the three-dimensional scanner further includes a scanner synchronization mechanism that generates scanner identification information corresponding to the trigger in response to reception of the trigger, and a measurement control part that synchronizes emission of the pattern light from the scanner light source, imaging by the scanner imaging part, and light emission of the markers,
the movable imaging part captures images of the markers of the three-dimensional scanner to generate the second image including the markers in response to generation of the trigger by the synchronization mechanism,
the camera image processing unit processes the second image generated by the movable imaging part to generate the second measurement information associated with the synchronization identification information,
the optical communication interface of the first wireless communication unit transmits the trigger generated by the synchronization mechanism to the three-dimensional scanner,
the three-dimensional scanner receives the trigger via the optical communication interface of the third wireless communication unit, and
the measurement control part synchronizes generation of the scanner identification information by the scanner synchronization mechanism, the emission of the pattern light from the scanner light source, the imaging by the scanner imaging part, and the light emission of the markers in response to the reception of the trigger via the optical communication interface of the third wireless communication unit.

11. The three-dimensional measurement device according to claim 10, wherein
the three-dimensional scanner transmits the first measurement information generated by the scanner image processing unit to the imaging unit via the radio communication interface of the third wireless communication unit in association with the scanner identification information corresponding to the first measurement information generated by the scanner synchronization mechanism, and
the imaging unit receives the first measurement information transmitted via the radio communication interface of the third radio communication unit, and transmits the second measurement information generated by the camera image processing unit and the first measurement information generated by the scanner image processing unit to the second radio communication unit via the radio communication interface of the first radio communication unit in association with each other based on the synchronization identification information associated with the second measurement information and the scanner identification information associated with the first measurement information.

12. The three-dimensional measurement device according to claim 10, wherein
the movable imaging part repeatedly captures images of the markers of the three-dimensional scanner a predetermined number of times in response to the generation of the trigger by the synchronization mechanism to sequentially generates the second images including the markers,
the camera image processing unit processes each of the second images generated by the movable imaging part to sequentially generate the second measurement information associated with the synchronization identification information sequentially generated by the synchronization mechanism, and
the measurement control part repeatedly executes the generation of the scanner identification information by the scanner synchronization mechanism, the emission of the pattern light from the scanner light source, the imaging by the scanner imaging part, and the light emission of the markers a predetermined number of times in response to the reception of the trigger.
